(19) United States
(12) Patent Application Publication
(10) Pub. No.: US 2009/0298505 A1
(43) Pub. Date: Dec. 3, 2009

(54) Profile Based Communications Service

(76) Inventors: Christopher Ridgway Drane, New South Wales (AU); Craig Andrew Scott, New South Wales (AU); Malcolm David MacNaughtan, New South Wales (AU); Stephen Brown, New South Wales (AU)

Correspondence Address: JONES DAY, 222 EAST 41ST ST, NEW YORK, NY, 10017, US

(21) Appl. No.: 12/084,484

(22) PCT Filed: Oct. 10, 2006
(86) PCT No.: PCT/AU2006/001479

§ 371 Date: Jul. 27, 2009

(30) Foreign Application Priority Data
Nov. 4, 2005 (AU) 2005906105

(51) Int. Cl. H04W 16/00; H04W 4/00

(52) U.S. Cl. 455/446; 455/422.1

(57) ABSTRACT

A mobile radio communications network is disclosed in which zones may be defined for provision of location based services and applications. Various methods are also disclosed for using the defined zones in different ways for different applications. The methods include associating users with zones, updating users of zones with changes to the zones, controlling zone size and dynamically uploading zone profiles to users based on the user's geographical location.

### TECHNICAL FIELD

The present invention relates to mobile radio communications networks and to services provided in relation thereto.

### PRIORITY CLAIM

The present application claims priority from Australian Provisional Patent Application No. 2005906105, the entire content of which is hereby incorporated by reference.

### INCORPORATION BY REFERENCE

The following co-pending patent applications are referred to in the following description:

PCT/AU2006/000478 entitled “Enhanced Terrestrial Mobile Location” to the applicant of the present application;
PCT/AU2006/000479 entitled ‘Mobile Location’ to the applicant of the present application;
PCT/AU2006/000347 entitled ‘Enhanced Mobile Location Method and System’ to the applicant of the present application;

### W. C. Y. Lee, Mobile Communications Engineering. McGraw-Hill, 1982;

P. L. H. A. S. Fischer, Evaluation of positioning measurement systems,” T1P1.5/97-110, December 1997;
IEEE VTS committee, Coverage prediction for mobile radio systems operating in the 800/900 MHz frequency range, IEEE Transactions on VTC, Vol 37, No 1, February 1998;
“Computational Geometry in C (Cambridge Tracts in Theoretical Computer Science)”, Joseph O'Rourke, Cambridge University Press; 2000 edition, ISBN 0521649765;
Section 2.7 of Mobile Radio Communications 2^{nd} Ed. Editors Steele and Hanzo. ISBN 047197806X, J. Wiley & Sons Ltd, 1999.
the entire contents of each of which are hereby incorporated by reference.

### BACKGROUND

In the mobile telecommunications market, a current area of activity is in service differentiation based on subscriber location. One example of this is a home zone service. One type of service provided by a home zone system is that a subscriber can be charged a lower tariff when using a service from within the home zone and a normal mobile tariff at other times.

Some of the fundamental technical issues to be solved in deploying service differentiation based on spatial zones relate to the definition of the zone and efficient detection as to whether the subscriber is in or out of the zone. Current systems typically identify one or more cell sites in the vicinity of the home zone and include them in a home zone profile. Whenever the mobile radio terminal is registered with any one of the profile cells, the subscriber is deemed to be within the zone, otherwise they are deemed to be outside.

Location based services also have applications in many other areas including commercial advertising, emergency rescue, gaming and education.

The commercial usefulness of such systems is dependant at least in part, on the applications and flexibility of the system to provide better and more varied services to customers or users.

It is an object of the present invention to provide a method and system that enhances the usability of location-based applications.

### SUMMARY

According to one aspect of the present invention, there is provided a method of propagating to a user of a zone, information relating to the zone, the method comprising:
associating the user with the zone; and
transmitting information relating to the zone to the associated user.

In one form, the method further comprises associating a plurality of users with the zone.

In another form, the method further comprises associating a plurality of zones with the user.

In another form, the method further comprises associating the plurality of zones with a plurality of users.

In one form, the information relates to a change in size of the zone.

According to another aspect of the present invention, there is provided a mobile radio communications network having at least one zone and at least one user of that zone, the mobile radio communications network comprising:
a database having stored thereon a profile of the at least one zone and association data associating the at least one user with the at least one zone;
a receiver for receiving information relating to the at least one zone; and
a transmitter for transmitting information relating to the at least one zone to the associated at least one user.

In one form, the database further comprises association data associating a plurality of users with the at least one zone.

In another form, the database further comprises profiles for a plurality of zones.

In another form, the database further comprises association data associating the at least one user with the plurality of zones.

In a further form, the database further comprises association data associating a plurality of users with the plurality of zones.

According to another aspect of the present invention, there is provided a database for use with a mobile radio communications network having at least one zone and at least one user of the at least one zone, the database having stored thereon:
a profile of the at least one zone and association data associating the at least one user with the at least one zone.

In one form, the database further comprises association data associating a plurality of users with the at least one zone.

In another form, the database further comprises profiles for a plurality of zones.

In a further form, the database further comprises association data associating the at least one user with the plurality of zones.

In another form, the database further comprises association data associating a plurality of users with the plurality of zones.

According to another aspect of the present invention, there is provided a method of making available one or more zone profiles to a mobile radio terminal in a mobile radio communications network, the method comprising:
detecting the mobile radio terminal entering a zone in the mobile radio communications network; and
upon detecting that the mobile radio terminal has entered the zone, transmitting a transmission making available to the mobile radio terminal, a profile of the at least one sub-zone associated with the zone.

In one form, the transmission comprises the profile of the at least one sub-zone.

In another form the transmission comprises an instruction to activate the profile of the at least one sub-zone in the mobile radio terminal.

In another aspect, the method further comprises:
detecting when the mobile radio terminal leaves the zone; and
upon detecting that the mobile radio terminal has left the zone, transmitting a further transmission to the mobile radio terminal, making unavailable, the profile of the at least one sub-zone.

In one form, the further transmission comprises instructions to the mobile radio terminal to delete the profile of the at least one sub-zone.

In another form, the further transmission comprises instructions to the mobile radio terminal to deactivate the profile of the at least one sub-zone.

In another aspect, the method further comprises:
upon detecting that the mobile radio terminal has entered the zone, determining whether the zone has one or more sub-zones associated therewith.

According to another aspect of the present invention, there is provided a mobile radio communications network for providing one or more zone profiles to a mobile radio terminal, the mobile radio communications network comprising:
a database containing profiles for a zone and at least one sub-zone;
a zone transition detector for detecting when the mobile radio terminal enters the zone; and
a transmitter for transmitting a transmission to the mobile radio terminal when the zone detector detects that the mobile radio terminal has entered the zone, to provide the profile of the at least one sub-zone to the mobile radio terminal.

According to another aspect of the present invention, there is provided a mobile radio terminal for use in a mobile radio communications network having a zone and at least one sub-zone of the zone, the mobile radio terminal comprising:
a memory having a profile of a zone stored thereon;
a transmitter for transmitting a signal to the mobile radio communications network upon the mobile radio terminal entering the zone;
a receiver for receiving from the mobile radio communications network a transmission providing a profile of a sub-zone within the zone; and

In one form, the memory is a SIM card.

According to another aspect of the present invention, there is provided a mobile radio terminal for use in a mobile radio communications network having a zone and at least one sub-zone associated with the zone, the mobile radio terminal having:

a memory having profiles of the zone and the at least one sub-zone stored thereon, wherein upon receipt of an instruction from the mobile radio communications network, the at least one sub-zone profile is activated.

In one form, the instruction from the mobile radio communications network is transmitted upon the mobile radio terminal entering the zone.

According to another aspect of the present invention, there is provided a method of controlling the size of a zone in a mobile radio communications network, the zone being defined by at least one signal strength measurement for a cell in the mobile radio communications network, the method comprising:
varying a standard deviation for the at least one signal-strength measurement.

In one form, the method further comprises varying the standard deviation for respective signal strength measurements for each cell in the zone definition.

In one form, the zone size is made smaller by decreasing the standard deviation.

In another form, the zone size is made larger by increasing the standard deviation.

### FIGURES

Various aspects of the present invention will now be described in detail with reference to the following figures in which:

FIG. 1—shows one method of defining a zone profile for use in various aspects of the present invention;

FIG. 2—shows an exemplary network arrangement in which various aspects of the present invention may be applied;

FIG. 3—shows an exemplary network for provisioning zones;

FIG. 4—shows an exemplary network for associating a zone with an existing zone profile with a user;

FIG. 5—shows an exemplary network for copying a newly registered zone;

FIG. 6—shows an exemplary network for distributing updated zone profiles;

FIG. 7—shows a flowchart for distributing a new or updated zone profile to all associated users;

FIG. 8—shows an exemplary network for disassociating a user from a zone;

FIG. 9—shows an exemplary network for deleting a zone;

FIG. 10—shows a flowchart for deleting a zone;

FIG. 11—shows fine grained (Child) zones within a larger (Parent) zone;

FIG. 12—shows a flowchart for child zone uploading;

FIG. 13—shows a signal-timing diagram between a mobile radio terminal and a location server as the mobile radio terminal enters a parent zone;

FIG. 14—shows a signal-timing diagram between a mobile radio terminal and a location server as the mobile radio terminal leaves the parent zone;

FIG. 15—shows a signal-timing diagram between a mobile radio terminal and a location server as the mobile radio terminal enters a child zone;

FIG. 16—shows a signal-timing diagram between a mobile radio terminal and a location server as the mobile radio terminal leaves the child zone;

FIG. 17—shows the resizing of a zone;

FIG. 18—shows another example of resizing of a zone;

FIG. 19—shows an exemplary network for unsuccessful validation with optional operator notification;

FIG. 20—shows an exemplary network for assigning and revoking registration permission;

FIG. 21—shows a group of zones;

FIG. 22—shows an exemplary network for real-time update of zone status;

FIG. 23—shows an exemplary network for message acknowledgement; and

FIG. 24—shows an exemplary network for message acknowledgement with message delivery.

### DETAILED DESCRIPTION

The present invention will now be described in detail with reference to one or more embodiments of the invention, examples of which are illustrated in the accompanying drawings. The examples and embodiments are provided by way of explanation only and are not to be taken as limiting to the scope of the invention. Furthermore, features illustrated or described as part of one embodiment may be used with one or more other embodiments to provide a further new combination. It will be understood that the present invention will cover these variations and embodiments as well as variations and modifications that would be understood by the person skilled in the art.

Throughout this specification, the term “mobile radio terminal” is used synonymously with terms such as “mobile phone”, “cell phone” or “handset”, and will be understood to encompass any kind of mobile radio terminal such as a cell phone, Personal Digital Assistant (PDA), lap top or other mobile computer, or pager.

It will also be understood that much of the processing that occurs in the implementation of various aspects of the present invention can also be distributed between the handset, one or more network elements within the radio communications network and/or one or more elements outside the radio communications network.

References to a user imply a user, their mobile terminal or their SIM.

References to a zone apply to physical and logical zones unless otherwise stated or the context clearly indicates one or the other.

In co-pending PCT Patent Application No. PCT/AU2006/000478 entitled “Enhanced Terrestrial Mobile Location”, the entire contents of which is herein incorporated, various techniques and methods for defining one or more zone profiles are disclosed in detail.

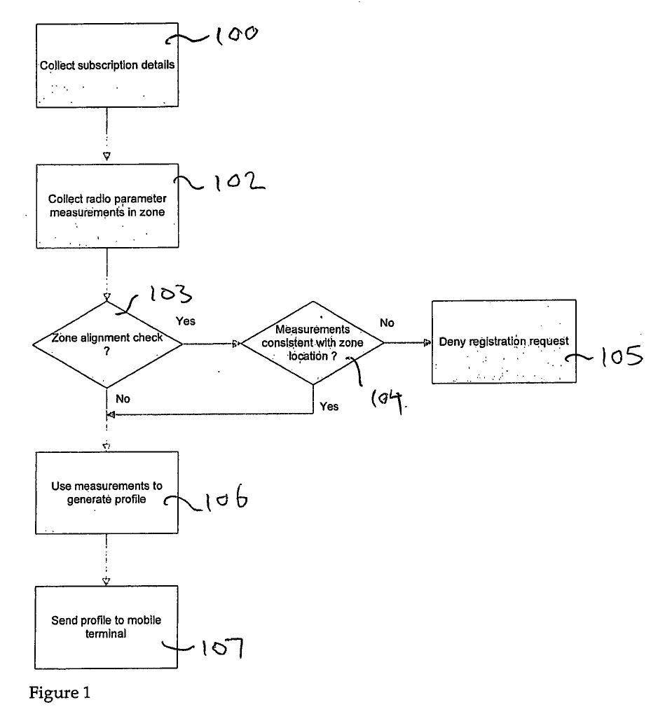

One of these methods is now briefly described. In one embodiment, the profile is derived from measurements made by the subscriber's or user's mobile radio terminal from within their zone. This measurement process may be initiated by the subscriber selecting a menu entry on their mobile radio terminal. Alternatively the process may be initiated remotely by a network based server. An example of such a set of measurements is provided below. The process of deriving the profile in this case is as illustrated in FIG. 1, which illustrates process 100. In an optional first step 100, subscription details for the subscriber of the mobile radio terminal are collected. In step 102, the mobile radio terminal collects radio parameter measurements within its zone or region. The mobile radio terminal will then transmit these measurements to a network processor for example. An optional step 103 is for the network processor to conduct a zone alignment check as described in more detail below to ensure that the measurements are valid. If the check is done, and the measurements are deemed to be valid (104), the system will proceed to generate the profile at step 106. If the measurements are deemed to be invalid (i.e. inconsistent with the zone location), the registration request is denied at step 105. Once the profile has been generated, it is, in this example, sent to the mobile radio terminal.

Other methods of generating the profile are described in this incorporated reference. The various aspects of the present invention are also equally applicable to other methods which generate a representation of a zone, no matter how course. Other methods are described further below.

Once a zone profile has been generated, many different processes may be applied to it to provide numerous options to both users and service providers. The present application describes these processes.

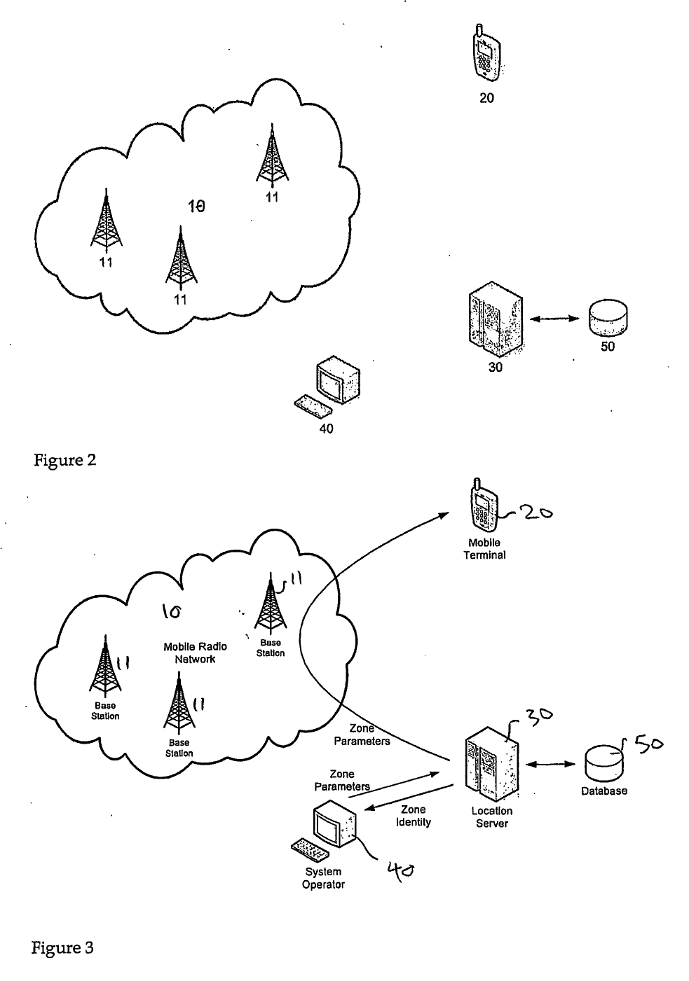

FIG. 2 shows an exemplary mobile radio network arrangement in which the various processes may be applied. Shown there is a network 10 containing a number of Base Stations 11 for communicating with one or more radio mobile terminals 20. Also associated with network 10 is Location Server 30 and network database 50. A system operator 40 may also be present for managing various aspects of the network 10.

### Provisioning Zones

To facilitate the initialization and application of a zone, the zone may be provisioned. An aspect of this provisioning process is the generation of an identifier that enables the zone to be uniquely identified. As shown in FIG. 3, in one embodiment, the location server 30, when requested to provision a zone, generates a unique identifier that is associated with that zone.

The unique identifier can be generated by using any one of a number of algorithms well known in the art. Examples include using a number sequence which is incremented as each zone is provisioned. Another example is to use a feature common to many databases whereby each item in the database can be assigned a unique key, usually represented as a number. An alternative embodiment is to allow the zone to be assigned a name upon creation whereby the request would be rejected by the location server 30 if the name provided was already assigned.

An alternative embodiment is for the unique identifier to be provided as a zone parameter and for the location server 30 to check against the database 50 to ensure the specified identifier is not already in use. Optionally the process of provisioning can include the specification of a zone location to support zone location validation. Optionally the process of provisioning a zone can specify the criteria for coverage validation. Optionally the zone parameters include parameters that are forwarded to the user's mobile terminal to support the user's use of the zone. An example of such a parameter is a name that the user can associate with the zone; for example “Home”. All details of the zone are stored in the database.

Associating a User with a Zone

In the previously-incorporated PCT application, a zone is initialized by a registration process in which a user moves around within a region while the mobile radio terminal makes radio measurements of that zone. Those measurements are subsequently processed to create a radio profile that defines the zone. For zone based services designed for use by more than one user, the registration process can be streamlined so that only one mobile radio terminal is required to complete the registration. The resulting profile can then be archived and simply applied for any additional users to the service in that zone. In the case of a handset based zone detection process the profile can be provided to the user's handset for instance via over the air download.

In one aspect of zone sharing there is a facility whereby a given user can be associated with a zone. The zone is identified via a unique identifier as previously described. When a user is associated with a zone, the user is optionally sent a message containing parameters of interest as described elsewhere in this specification. The new relationship between the zone and the user is maintained in the database. This process enables one or more users to share a common zone definition.

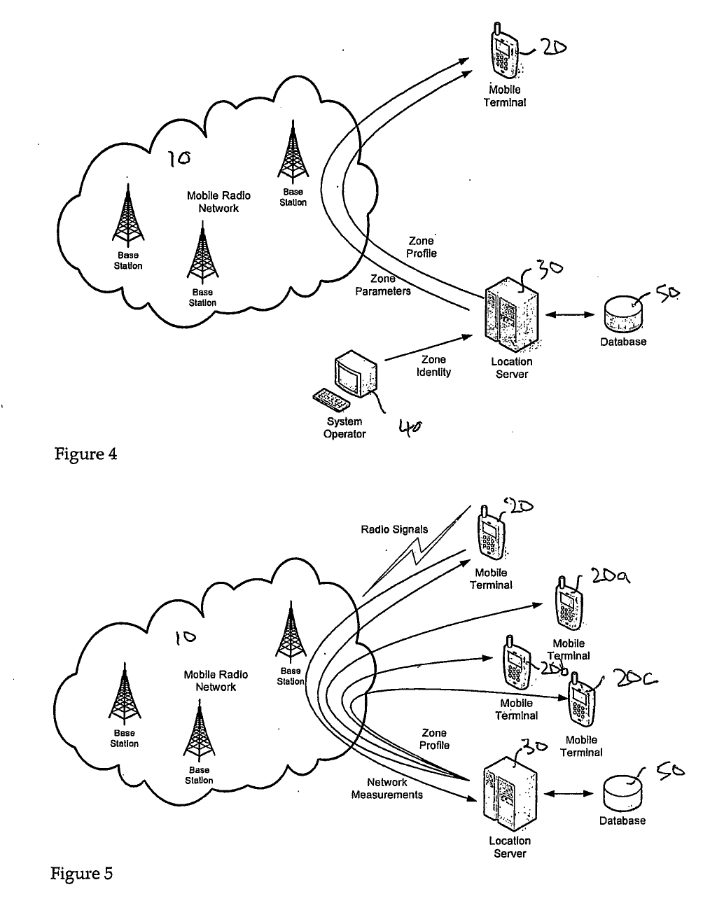

In one embodiment, the zone detection process is performed in the mobile and in this embodiment, the zone definition needs to be available in the mobile. If at the time of zone association the zone profile already exists, the zone profile or definition is sent to the mobile radio terminal. FIG. 4 shows the zone profile and zone parameters being sent to the mobile radio terminal 20 by the location server 30 via network 10.

A user can be associated with a zone that has not yet been initialized. If there are zone parameters associated with the zone, these are sent to the mobile radio terminal at this time. When the zone is successfully initialized, the resulting zone profile is sent to all users currently associated with the zone. Similarly should the zone ever be re-initialised, all users associated with the zone will be sent the newly generated zone profile. In FIG. 5, there is shown mobile radio terminal 20 measuring radio signals from the network 10 and sending resulting network measurements to location server 30. Location server 30 then calculates the zone profile from the received network measurements and transmits the zone profile to the other mobile radio terminals 20a, 20b and 20c that are currently associated with that zone.

In some cases, zone profiles may be updated as a result of network changes, leading to different network measurements for a given zone. Should a zone profile be so updated the updated profile may be sent to all users associated with the zone.

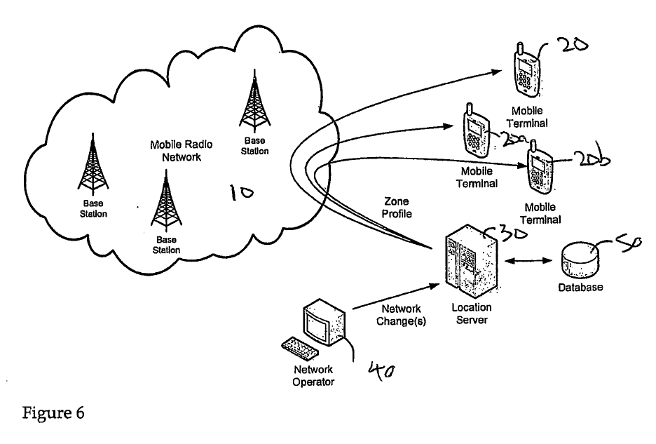

FIG. 6 shows how the network operator 40 (in one example), informs the location server 30 of changes to the network. The location server 30 may then recalculate zone profiles for potentially-affected zones and compare these with the corresponding zone profiles in database 50. If the comparison indicates that the zone profile for a given zone has changed due to the network changes, location server 30 then transmits an updated zone profile to each of the associated mobile radio terminals 20, 20a and 20b via network 10.

It will of course be appreciated that information relating to network changes may be provided by any other means, including automatic regular measurement of network parameters.

It will also be appreciated that zone profiles may change for other reasons. One such reason is a redefining, or resizing of a particular zone, as will be discussed in more detail further below.

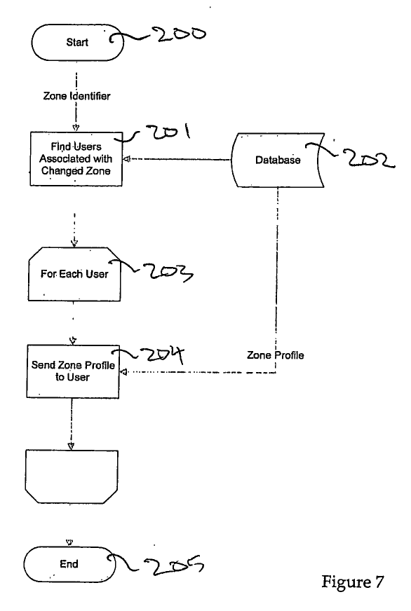

FIG. 7 shows a flowchart of the steps taken to perform the zone profile update described above, starting at step 200. Upon being informed of a change in the network and a change in a particular zone, in step 201, the system finds the users associated with the changed zone by reference to database 50 (step 202). For each identified user (203), the system sends the updated profile before ending in step 205.

In one aspect of the invention there is a facility to register a user with the location server. In one form, registering a user results in zone-based location software being downloaded onto the user's mobile radio terminal 20. In another form, registering a user results in the location server 30 sending the user's mobile radio terminal 20 a message to activate the software that was pre-installed on the mobile radio terminal 20 but which has been dormant. In yet another form, the first provisioning action on an unregistered user causes the registration action(s) to occur before the requested provisioning action is performed.

Disassociating a User from a Zone

In one aspect of zone sharing there is a facility whereby a given user can be disassociated from a zone. In one embodiment, the zone detection process is performed in the mobile radio terminal and hence the zone definition and other zone parameters need to be deleted from or otherwise deactivated for the mobile radio terminal when the zone is disassociated. This is achieved by sending a message to the mobile radio terminal that commands the mobile radio terminal to delete or otherwise deactivate the specified zone.

Such a message could be encoded as a command byte indicating the delete zone command followed by the number of zones to delete followed by a series of zone identifiers indicating the zones to delete. This format allows multiple zones to be deleted in one message. Table 1 illustrates a message to delete 2 zones with zone IDs 515424 and 414251 respectively. The command value 12 is interpreted as a command to delete a zone.

TABLE 1

| | Command | NumZones | Zone ID | Zone ID | . . . |
|---|---|---|---|---|---|
| Value | 12 | 2 | 515424 | 414152 | |
| NumBytes | 1 | 1 | 4 | 4 | 4 |

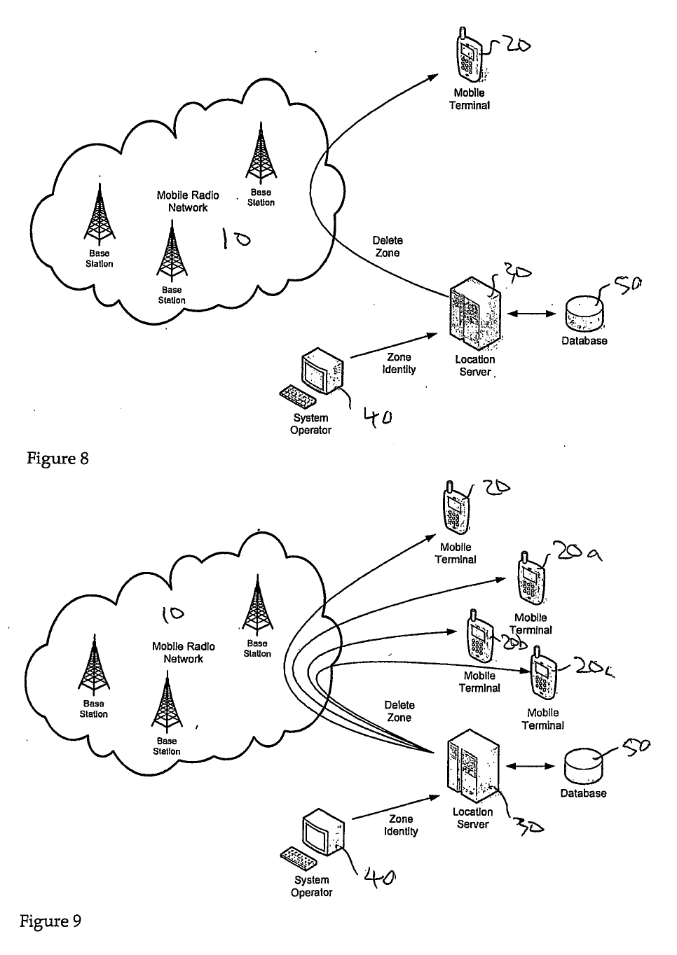

FIG. 8 illustrates an exemplary network configuration in which a user may be disassociated from a zone. In one form, the system operator 40 can instruct the location server 30 to disassociate an associated user from a given zone. Location server 30 sends an instruction to mobile radio terminal 20 via network 10 to delete or otherwise deactivate the zone so that the zone is no longer relevant to mobile radio terminal 20. Location server 30 may also update database 50.

This application may be used in instances where the system operator has been informed for example that the user of mobile radio terminal has not paid a bill for the service, or has otherwise violated a condition of a contract that may be associated with the service using the deleted zone. In another application, a service associated with a particular zone may become discontinued, and the relevant zone may then need to be deleted from users' mobile radio terminals.

In the case where multiple users are to be disassociated with the given zone, the instructions for deletion or deactivation may be sent to each of the mobile radio terminals associated with the zone. One network arrangement for this is as shown in FIG. 9, in which system operator 40 instructs location server 30 to disassociate four users associated with the given zone. Again, location server sends the instructions to each mobile radio terminal 20, 20a, 20b and 20c via network 11. Database 50 may also be updated.

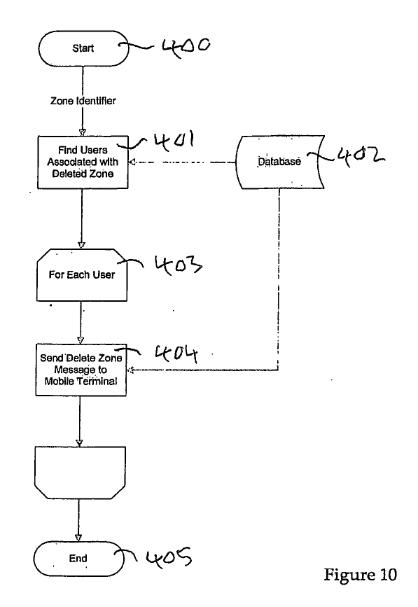

FIG. 10 is a flowchart showing the steps used in one method of deleting a zone. Starting at step 400, the method locates users in step 401 who are associated with the zone to be deleted by reference to database 50 in step 402. In step 403 and 404, for each user, the system sends the delete or deactivate zone message to the mobile terminals affected, before ending in step 405.

### Authorisation

In an optional aspect, the system implements an authorization scheme to control access to zone definitions associated with a user and to control who is permitted to request a zone definition be associated with a given user. For example a parent is granted the authority to request that a zone that they generated for their home be associated with one of their children. If the user making a request does not have the authority to request the specified zone or does not have the authority to request a zone be associated with the specified user, then the system will reject the request.

### Pool of Common Zone Definitions

In another aspect of the present invention, there is a facility for zone definitions to be placed in a common repository from which the system can use to set up zone-based services on a mobile without having to require each user to register the zone. As an example consider a service that monitors whether school children's mobiles are within the vicinity of the school during school hours. In this case rather than having each child who will be subscribed to the service complete the registration process, only a single registration cycle is required. The profile derived from this cycle is then retained and provided to each additional mobile that is to be subscribed to the service for that school. A similar arrangement to that shown in FIG. 5 may be used in this aspect, in which a mobile radio terminal 20 is used to define and register a zone profile for the school. This zone profile may then be stored on database 50. Any other students wishing to register themselves for this school zone would then have the pre-registered zone profile transmitted to their respective mobile radio terminals 20a, 20b and 20c.

In the case where the zone profile is generated in the mobile the zone definition can be shared by sending the profile directly over-the-air, for example via SMS, to other mobiles or indirectly by sending the zone profile to a server which then distributed the zone definition to other mobiles.

### Zone or Location Based Uploading of Zone Definitions.

In another aspect, there is provided a facility whereby a user is automatically sent one or more zone profiles based on their location. In one embodiment, the location is based on a coarse profile representing a large area and once the user is detected entering that area the location server sends one or more zones of relevance to that user's mobile terminal. Optionally when the user is detected leaving the zone the location server instructs the user's mobile radio terminal to delete the zones. In an alternative option, when zone profiles for the sub-zones are uploaded and for which there is insufficient unused storage capacity, the zone profiles replace the oldest of any sub-zones already present on the mobile.

In an alternative embodiment, all of the zones may already be downloaded onto the mobile radio terminal, and the instructions from the network activate and deactivate relevant zone profiles as appropriate.

For a mobile based zone detection process, the benefit is that the limited storage capacity at the mobile is not overrun with a large number of fine grained or sub profiles. Instead a smaller number of coarse profiles can trigger the download of finer grained or sub profiles of immediate relevance.

The zone profiles can take many forms depending upon the zone detection methods being employed. One form of a zone profile is that described in incorporated reference PCT/AU2006/000478. Another form is a circular zone specified by a point, for example easting and northing or latitude and longitude, and a radius. As described previously, the zone will have an associated unique identifier. An example of the implementation of such a zone and its identifier is shown in Table 2. In such an implementation the mobile would be declared in the zone if the distance from its estimated location to the specified point is less than the radius of the zone.

TABLE 2

| Zone ID | Easting | Northing | radius (m) |
|---|---|---|---|
| 515637 | 570691 | 5561943 | 500 |

Yet another form is a zone defined by a polygon. Again the zone profile will have an associated unique identifier. Such a polygon can be defined by a series of points and an associated sequence number. The boundary of the zone is defined by lines joining points in turn with the last point being joined with the first point to enclose the polygon.

A mobile radio terminal is declared to be in the zone if its estimated location is inside the polygon. Algorithms for determining if a point is inside a polygon are well known in the art, for example “Computational Geometry in C (Cambridge Tracts in Theoretical Computer Science)”, Joseph O'Rourke, Cambridge University Press; 2000 edition, ISBN 0521649765, the entire contents of which is hereby incorporated by reference.

Table 3 illustrates the definition of a rectangular zone formed by joining points 1-2, 2-3, 3-4 and 4-1.

TABLE 3

| Zone ID | Point Num | Easting | Northing |
|---|---|---|---|
| 668901 | 1 | 4556172 | 6687192 |
| 668901 | 2 | 4556172 | 6687392 |
| 668901 | 3 | 4555972 | 6687592 |
| 668901 | 4 | 4555772 | 6687192 |

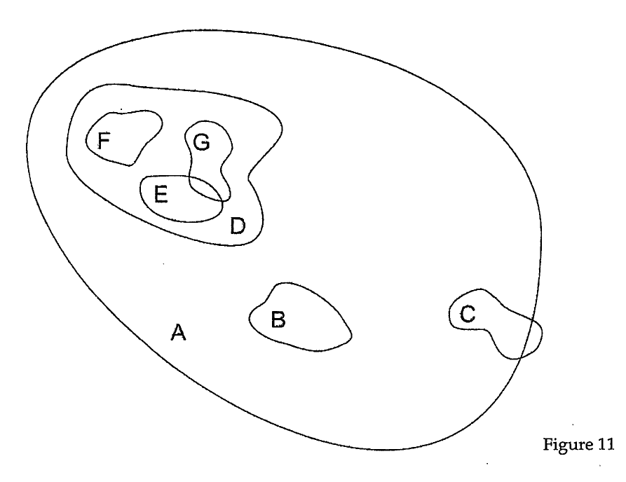

FIG. 11 illustrates an example of this application. A user has zone A on their mobile radio terminal. When the mobile radio terminal reports to the location server that it has entered zone A, the location server downloads the zone profiles of all the zones that have been defined as sub-zones of zone A. In FIG. 11, this means that zones B, C, and D are downloaded. The hierarchy of zones is not limited to a single set of zones. When the user now enters zone D, a further set of sub-zones E, F, and G are uploaded. It will be appreciated that the sub-zones do not necessarily have to lie entirely within the zone to which they are assigned. The zone may lie partially or entirely outside the boundary of the “parent” zone, as is the case with sub-zone C.

To support the process, there exists a facility to associate a child zone or sub-with a parent zone or zone. The child and parent zones are identified via a unique identifier as previously described. For example, there is a series of zones labeled for convenience A through G with unique identifiers as shown in Table 4. Zone B is associated as a child of zone A by specifying that zone identifier 61561823 be a child zone of the zone represented by 72862. The process is repeated for associated zones C and D with A and zones E, F, and G with zone D to create the relationship illustrated in Table 5. In the preferred embodiment the relationship modeled via the data in Table 5 would be stored as a table in the database. The parent-child relationship can be established prior to the zones being initialized.

Various methods are available for detecting a zone transition, including methods as described in detail in the incorporated reference PCT/AU2006/000478.

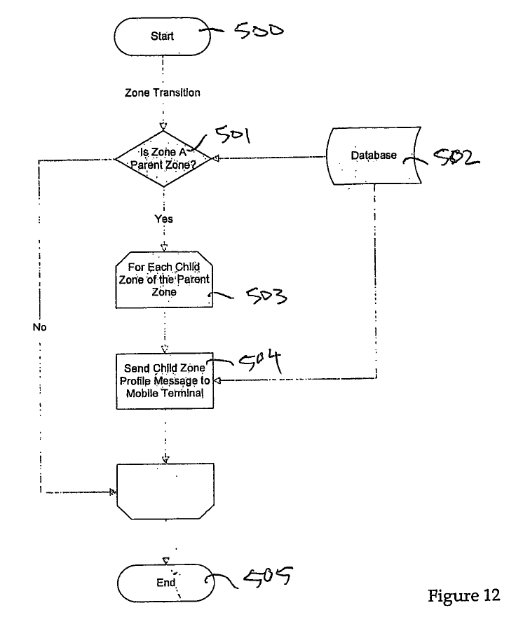

FIG. 12 is a flowchart showing the steps followed in one form of this application. The method begins at step 300, after which a zone transition is detected. At step 301, the system determines whether the entered zone is a parent zone (i.e. associated with one or more child or sub zones) with reference to the database 50.

If the entered zone is determined to be a parent zone, in steps 303 and 304, the system sends a copy of each determined child zone to the mobile radio terminal. If the entered zone is determined not to be a parent zone in step 301, the process ends at step 305 and no child or sub zones are provided to the mobile radio terminal.

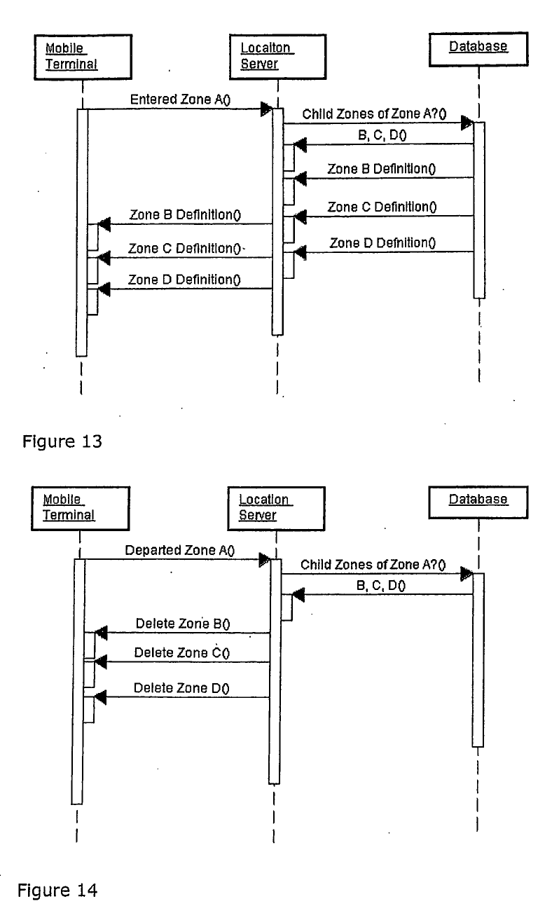

In one embodiment, the zone detection process is performed in the mobile radio terminal. When the zone detection process determines that the status of the mobile terminal with respect to any of the zone definitions stored in the mobile has changed, the mobile terminal sends a message, for example using SMS, to the location sever (network processor). The location server examines the status of each zone. When a zone status has changed, the location server checks to see if the zone is a parent zone. If the zone is a parent zone, the location server sends each of the child zones to the mobile terminal. For example a mobile terminal with the definition of zone A, and possibly one or more other zones installed, reports to the location server that it has entered zone A (zone identifier 72862). The location server determines that zone A is a parent to zones B, C, and D; zone IDs 61561823, 75283, and 61517 respectively (Table 5). The location server associates the mobile radio terminal with zones B, C, and D and consequently proceeds to send the zone definitions or profiles for zones B, C, and D to the mobile terminal (see FIG. 13). When the mobile radio terminal leaves zone A, the mobile notifies the location server which in turn determines that zones B, C, and D are child zones of A and the location server disassociates these zones from the mobile terminal and consequently sends one or more messages to the mobile terminal to delete each such zone from the mobile terminal, as shown in FIG. 14.

TABLE 4
Zone identities

| Zone | ID |
|---|---|
| A | 72862 |
| B | 61561823 |
| C | 75283 |
| D | 61517 |
| E | 55410 |
| F | 61239 |
| G | 615413 |

TABLE 5
Parent - Child Zone relationship.

| Parent Zone ID | ChildZone ID |
|---|---|
| 72862 | 61561823 |
| 72862 | 75283 |
| 72862 | 61517 |
| 61517 | 55410 |
| 61517 | 61239 |
| 61517 | 615413 |

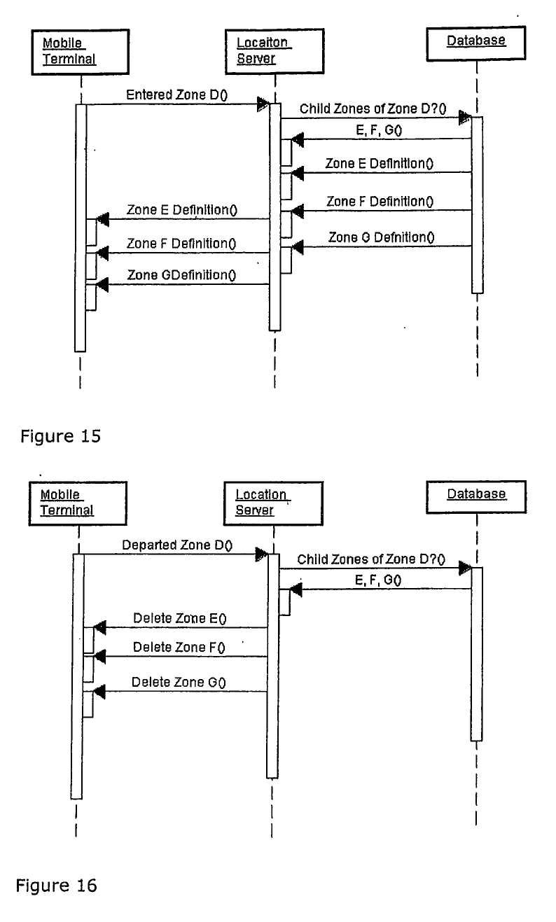

Prior to entering zone A, the mobile, for example has 2 zones, zone A and zone X. Upon entering zone A and receiving the new zone definitions the mobile now has 5 zones: A, X, B, C, and D. The mobile now enters zone D and is sent the zone definitions for zones E, F, and G as shown in FIG. 15. At this stage the mobile has 8 zones: A, X, B, C, D, E, F, and G.

Upon leaving zone D, the mobile is instructed via one or more the messages from the server to delete zones E, F, and G as shown in FIG. 16, leaving the mobile with 5 zones. Upon leaving zone A, the mobile is instructed to delete zones B, C, and D leaving the mobile with the original 2 zones A and X.

An example application of this aspect is a coarse profile representing a shopping mall having been stored in a user's mobile radio terminal. When the user is detected entering the shopping mall zone the location system sends to the user's mobile radio terminal one or more finer grained profiles corresponding to specific stores of interest to a that user. This can then be combined with spatially targeted advertising for example.

Another application for this might be for staff that travels between different offices in different cities. When they arrive in a city the zones for each of the local offices is downloaded enabling their location to be established whenever they are in one of the offices.

Another application is for tourists. As a tourist moves around a city, different zones are downloaded to their mobile. If they move within the vicinity of a zone, they can be notified of the nearby attraction, perhaps with a promotional offer. In such a case, entry into such a zone may trigger a further action from the location server or a 3^{rd} party system providing the promotional services.

Another application for this might be in a location based gaming application in which different parts or levels of a game being played via the mobile radio terminal can be entered as the user moves geographically from one zone to another, within a generally defined gaming zone.

Another application for this might be providing a service across an entire country, with the country being the parent zone, and different states being child or sub zones. Within each state or child zone, grandchild zones or sub-sub zones may be provided and uploaded to and deleted from the user's mobile radio terminal as the user travels from state to state.

The system provides an interface through which a system operator 40 can specify that a zone is declared to be associated with a parent zone for the purposes of uploading the zone whenever the parent zone is entered. One possible network arrangement in which this application may be used is as shown in FIG. 3.

### Zone Cloning

In another aspect of the invention there is a facility to duplicate a zone profile definition. This could be as simple as copying the data representing the zone to be cloned. The copy can then be resized by the system without affecting the original zone definition and thus not affecting the users who would be affected if the zone definition was changed. As an example, consider a location-sensitive billing application for which cheaper rates are offered when at home. The mobile phones of the occupants of a home share a common zone definition. The mobile operator offers a service whereby for a higher fee the home zone will be made larger, enabling calls to be made and received in neighboring houses. When an occupant takes up the enhanced service the original zone is cloned, resized and copied to the occupant's phone.

### Zone Resizing

In another aspect of the invention is a facility to change the size of a zone. In incorporated reference PCT/AU2006/000478 the boundaries of a zone are implicitly defined by a zone profile. Relaxing certain parameters of a zone profile will make the zone larger. Conversely tightening the parameters will make the zone smaller.

As described elsewhere in this specification when a zone profile is changed the changes are propagated to all affected mobile terminals. The re-sizing of a zone will cause such a change to a zone profile and as such when a zone is re-sized the new zone profile is propagated to all affected users. To re-size a zone for a subset of the users associated with a given physical zone, a clone of the physical zone is made and the clone is re-sized. In one form, the physical zone is deleted from those users, and the cloned and re-sized zone is added to those users. In another form, the original zone may simply be deactivated from the users' mobile radio terminals and the cloned and re-sized zones added.

TABLE 6
Physical Zone Profile

| CellID | ARFCN | BSIC | RxLevMean | Sigma |
|---|---|---|---|---|
| 25068 | 95 | 38 | −80.0 | 9 |
| 54763 | 81 | 59 | −88.3 | 9 |
| 18322 | 67 | 46 | −92.1 | 9 |
| 892 | 71 | 61 | −98.7 | 9 |
| 18581 | 73 | 34 | −101.3 | 9 |

TABLE 7
Physical Zone Profile Re-Sized to Make Zone Larger

| CellID | ARFCN | BSIC | RxLevMean | Sigma |
|---|---|---|---|---|
| 25068 | 95 | 38 | −80.0 | 11 |
| 54763 | 81 | 59 | −88.3 | 11 |
| 18322 | 67 | 46 | −92.1 | 11 |
| 892 | 71 | 61 | −98.7 | 11 |
| 18581 | 73 | 34 | −101.3 | 11 |

TABLE 8
Physical Zone Profile Re-Sized to Make Zone Smaller

| CellID | ARFCN | BSIC | RxLevMean | Sigma |
|---|---|---|---|---|
| 25068 | 95 | 38 | −80.0 | 7 |
| 54763 | 81 | 59 | −88.3 | 7 |
| 18322 | 67 | 46 | −92.1 | 7 |
| 892 | 71 | 61 | −98.7 | 7 |
| 18581 | 73 | 34 | −101.3 | 7 |

Table 6 above shows a zone profile as generated from a zone registration process. Table 7 shows the profile for the same zone after the extent of the zone has been increased by increasing by 2 dB the standard deviation for the signal strength for each cell referenced in the profile. The standard deviation represents an allowance for signal strength variations due to fast and slow fading effects and for the expected signal strength variations that occur across the zone due to the changing ranges to the various cells. Since the fast and slow fading effects are relatively consistent, increasing the standard deviation effectively increases the allowance for signal strength variation across the zone and thus the extent of the zone is increased. The mathematics of the zone detection process is described in previously incorporated reference PCT/AU2006/000478. The opposite of this applies whereby decreasing the signal strength standard deviation decreases the zone size as the relative cost of a difference between the reference signal strength and the observed signal strength is higher. Such a decrease is illustrated in Table 8.

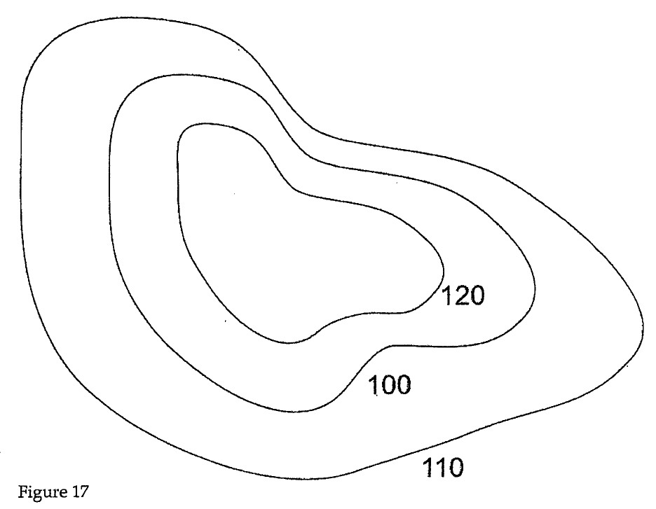

FIG. 17 shows the different zone sizes representative of the resizing done in Tables 6 to 8 above. The original zone is indicated as zone 100 (Table 6). The smaller zone 120 results from the tighter parameters (Table 8), and the larger zone 110 results from using the looser parameters (Table 7).

Table 9 shows another zone profile as generated from a zone registration process. Table 10 shows the profile for the same zone after the extent of the zone has been increased by increasing by 2 dB the standard deviation for the signal strength for each cell referenced in the profile.

TABLE 9
Zone profile

| Cell ID | Site | ARFCN | BSIC | RxLev | Sigma |
|---|---|---|---|---|---|
| 21702 | 2 | 88 | 8 | −72.2 | 7.0 |
| 21701 | 2 | 95 | 52 | −77.9 | 7.0 |
| 21703 | 2 | 99 | 29 | −89.2 | 7.0 |
| 21188 | 1 | 572 | 17 | −95.4 | 7.0 |
| 28576 | 4 | 622 | 27 | −96.6 | 7.0 |
| 21776 | 3 | 564 | 36 | −99.2 | 7.0 |
| 21176 | 0 | 648 | 4 | −99.8 | 7.0 |
| 28571 | 4 | 97 | 11 | −101.2 | 7.0 |
| 21171 | 0 | 101 | 23 | −101.4 | 7.0 |

TABLE 10
Zone profile after resizing to make zone larger.

| Cell ID | Site | ARFCN | BSIC | RxLev | Sigma |
|---|---|---|---|---|---|
| 21702 | 2 | 88 | 8 | −72.2 | 9.0 |
| 21701 | 2 | 95 | 52 | −77.9 | 9.0 |
| 21703 | 2 | 99 | 29 | −89.2 | 9.0 |
| 21188 | 1 | 572 | 17 | −95.4 | 9.0 |
| 28576 | 4 | 622 | 27 | −96.6 | 9.0 |
| 21776 | 3 | 564 | 36 | −99.2 | 9.0 |
| 21176 | 0 | 648 | 4 | −99.8 | 9.0 |
| 28571 | 4 | 97 | 11 | −101.2 | 9.0 |
| 21171 | 0 | 101 | 23 | −101.4 | 9.0 |

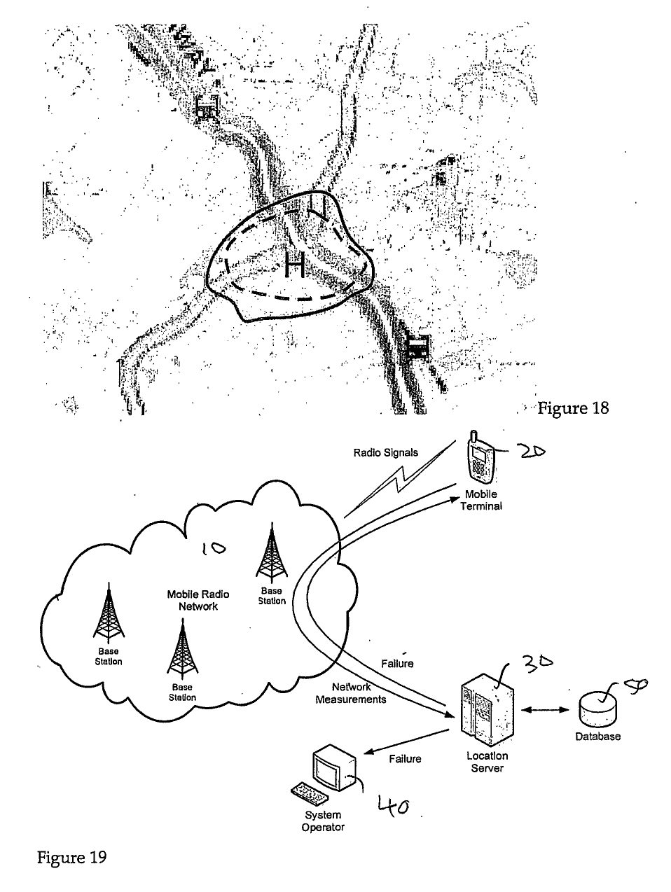

FIG. 18 shows the zone resizing over a map, representative of the resizing done in Tables 9 and 10. The zone boundary before resizing (Table 9) is shown as the dashed line and the zone as made larger (Table 10) is shown in solid line. H Marks the nominal location of the zone.

Increasing the value of sigma by 2 dB for example, for each cell in a profile increases the zone by approximately 10%. Decreasing the value of sigma by 2 dB for example, for each cell in a profile decreases the zone by approximately 10%. The radio environment will have an impact on the relative increase in zone extent of a 2 dB change. A 2 dB change would be expected to result in a larger relative increase in the extent of a zone compared to the same change applied to a zone in an urban environment. Below is provided a table of modelled data relating the change in sigma in dB with a commensurate change in zone size. The model does not take into account the unreported cell cost or the unknown cell cost.

| Delta | % zone |
|---|---|
| (dB) | change |
| 1 | −5% |
| 2 | −10% |
| 3 | −15% |
| 4 | −20% |
| 5 | −26% |
| 6 | −32% |
| 7 | −38% |
| 8 | −44% |
| 9 | −51% |
| −1 | 4% |
| −2 | 9% |
| −3 | 13% |
| −4 | 17% |
| −5 | 20% |
| −6 | 24% |
| −7 | 27% |
| −8 | 31% |
| −9 | 34% |

### Service Initialisation

In one aspect, before a zone-based service can operate, the zone definition must be created. This is achieved via a service initialization process. This process is managed via a combination of methods. In one form, a service may be able to only be initialized if permission has first been granted. Secondly, a feature may be provided to validate that a zone is initialized at a specified location. Thirdly, there may be provided a feature to ensure that there is sufficient coverage. These processes can be applied in any combination and in any order.

The system architecture for successful validation of zone measurements is shown in FIGS. 5 and 19. As shown in FIG. 5, the mobile radio terminal 20 makes measurements of the radio signals. These are sent to the location server 30 via network 10 using a protocol such as SMS. If the measurements are satisfactory then the zone definitions are generated and sent out to all users registered for that zone using a protocol such as SMS. As shown in FIG. 19, if the measurements fail the validation process, then the zone definitions are not generated. Optionally the system operator 30 is notified of the failure via protocols such as SNMP and SMTP. Optionally a message is sent to the mobile terminal (user) 20 via network 10.

### Initialisation Methods

### Initialisation Measurements

A set of radio measurements are made by the subscriber's mobile in the desired zone as part of service initialisation. Typically the subscriber will select a menu item on their handset to initiate the process. This menu can be provided by a program installed on the SIM card or alternatively an application run on the mobile terminal itself. In some cases however, a network based server may initiate the process by sending a message to the mobile. The mobile gathers a set of measurements over a short period of time, typically a few tens of seconds.

These measurements will typically include received signal levels and the associated identifiers of the corresponding cells. Timing measurements such as round trip delays or observed time difference measurements may also be included if available. These measurements will be sorted and filtered and finally the most useful elements provided for the analysis process.

In cases where the processing resources at the mobile are insufficient for the analysis processing, the measurements may be provided via wireless bearer to a network based server. The bearer may be for instance SMS, USSD or GPRS. In this case the server analyses the measurements to identify the cells whose signals are received in the zone as well as the typical signal levels and optionally timings. This process may optionally use data describing the configuration of the radio network and also a radio propagation model. This information is then transformed into a profile characterising that zone. The profile is relayed back to the mobile.

The analysis process optionally also includes checking for any cells in the vicinity that were not reported by the mobile. This may be due for instance to a site being down for maintenance at the time the zone was initialised. This step also involves the use of a network propagation model in the server. (It should be noted that the accuracy required of the network model in this step is far less exacting than that required to operate a zone service without the initialization measurements disclosed in this invention). Any missing cells identified by the server can be added to the profile before transmission to the mobile.

The profile also includes additional information enabling the zone detection algorithm to take account of ambiguous cell frequencies or identifiers in the zone as well as local radio propagation variability and varying interference levels. The process of generating the profile can also incorporate a variety of quality of service parameters. For instance an operator might wish to offer an initial period where the zone is less restrictive. The server can take this into account and generate a profile which allows the subscriber to move a larger distance from the nominated street address before being deemed to be out of the zone.

The server may optionally retain the initialisation measurements after creating the profile. These measurements may be re-used at a later time to generate a modified profile, for instance with different quality of service parameters.

The approach described here involving the use of these initialisation measurements in this way also enables a number of other service enhancements as detailed in later subsections.

### Alternative Gathering of Initialisation Measurements

In cases where the analysis to generate a profile is carried out at a network based server the present invention provides an alternative means for providing initialisation measurements from the mobile to the server. In this case, the initialization process involves the mobile connecting to the network, for instance by establishing a call. During a call a mobile periodically reports radio parameter measurements to enable the handover process in the radio network. These radio parameter measurements may be intercepted using signalling probes in the network and provided from there to the server for the profile generation analysis.

To trigger the measurement collection process, the user may call a specified phone number whilst situated in the zone where the service is to be registered. In the network, this call can be used trigger for the collection process. Optionally a pre-recorded message could be played to the user while the measurements are collected. Once sufficient measurements have been collected the call may also optionally be released automatically by the system. As in the case described above the collection process could also be initiated by the user via a menu provided on the phone rather than having to dial a particular number.

One benefit offered by this approach is that it does not rely on a facility in the phone to gather measurements and provide them to a server. This enables for instance GSM handsets with little or no support for SIM Toolkit functions to participate in a zone based service.

In a system employing this approach, the ongoing measurements used to update the subscriber's status can also be captured from the signalling probes when calls are originated or terminated by a participating mobile or when the mobile issues a periodic location update. In this case, the profile characterising each zone are retained by a network based server, which carries out the consistency checks between the profile and subsequent radio parameter measurements made by the mobile.

While many of the examples in the following sections are described in terms of a mobile based process for providing the initialisation measurements to the server and also for carrying out the periodic consistency checks, it should be noted that this alternative of a probe based measurement gathering process is also applicable.

### Triggering Initialisation Measurements

One method of obtaining zone initialisation measurements is for the user to activate a feature on the mobile as described in the incorporated reference PCT/AU2006/000478. An alternative or complimentary approach is to trigger the gathering of measurements from the network. The user contacts the system operator from within the zone that they wish to initialise and the system operator via the location server sends a message to the user's mobile commanding the mobile to gather the required measurements.

Remotely triggering the gathering of initialisation measurements provides a means of gathering initialisation measurements where the user has difficulty activating the feature from the mobile phone; for example the visually impaired. The method also has the advantage of the system operator being able to talk the user through the process ensuring that it is carried out correctly. When used as the sole means of gathering initialisation measurements, the method has the inherent advantage of controlling who registers a given zone without the explicit use of permissions described elsewhere in this specification.

### Registration Permission

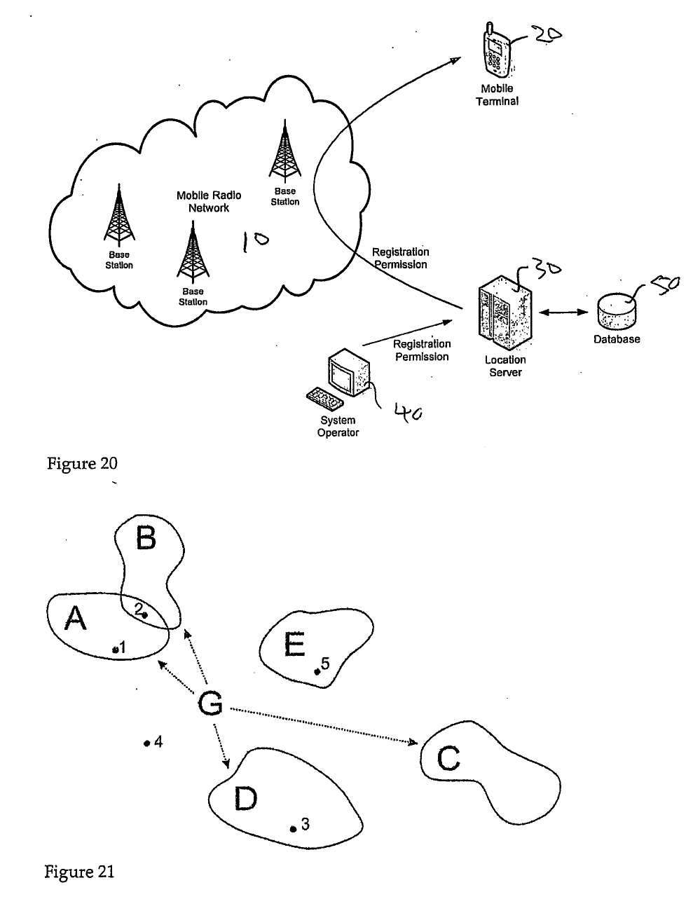

In one form of zone-based location system the zone definition is generated based on radio measurements made while the user moves around within the zone. This process is referred to as zone initialisation or zone registration. In one aspect of the system, access to the zone registration process is controlled via permissions granted and revoked for a given user and given physical zone. The system can grant a user's permission to register a given zone. The system can also revoke a user's permission to register a given zone. Optionally, once a user registers a zone the registration permission is revoked. This can be applied by the mobile radio terminal 20 at the time of registration or via a message from the server 30 sent in response to the receipt of the registration data message from the mobile radio terminal, as shown in FIG. 20. Optionally, once a user has registered a zone the registration permission is automatically revoked from all users who had permission to register that zone. The registration permission is granted and revoked via a message, such as SMS, sent from the server to the user's mobile phone. Optionally the system notifies the user when zone registration permission for a zone has been granted or revoked.

Controlling permission to register a zone has the following advantages: The user is prevented from accidentally activating the zone registration feature on the mobile terminal and also that the user is prevented from changing where a service is operating. For example in a local phone replacement service, the system operator may not want users to be arbitrarily changing the location at which the user gets local call rates.

In one embodiment, the user's mobile terminal will block access to the zone registration function for all zones except those for which the user has been granted registration permission. An alternative embodiment is for the registration permission to be applied in the server whereby users can register a zone at any time but the server will reject any such registration message unless the user has permission to register a zone.

A user can be granted permission to register a new zone. For such zones there will be no IN/OUT status until such time as the zone is registered. A user can be granted permission to re-register a zone for which there already exists a zone profile. The preferred embodiment for re-registration is to leave the existing zone profile definition in place and operational with respect to the zone detection algorithm until such time as the zone is re-registered by the user and a new zone profile definition generated which is then sent to the user(s) to overwrite the existing zone profile. An example use for re-registration is where the commissioning of a new cell near a zone has affected the performance of the zone detection and in response a user of the zone has been granted permission to re-register the zone.

As an example of this embodiment, consider a mobile terminal that has 4 physical zones denoted A, B, C, and D and that the mobile terminal does not have permission to register any of the zones. If the user seeks to activate the zone registration feature on the mobile terminal the user will find that they cannot activate the feature. The server subsequently sends the mobile a message to grant permission to register zone B. Should the user now seek to activate the zone registration feature on the mobile terminal the user will find that they are allowed to register zone B.

### Coverage Validation

In some zone based services, the quality of the radio network coverage may be a critical factor. The present system can include checks on the radio network coverage as part of the service initialisation process.

As an example, consider a case where the present system is being used to offer a mobile based fixed line replacement in the user's home. For this to be viable, the coverage of the mobile radio network must meet some minimum quality requirements. While most operators maintain coverage maps for their network, these do not include accurate characterisation of individual homes. As a result there is a small likelihood of a new user subscribing to the service, disconnecting their existing fixed line only to discover that the mobile network coverage is inadequate and they are left without continuous telephone connectivity.

The present system can address this potential issue during the service initialisation phase. Additional processing can be performed at the service initialisation stage, to determine the reliability of the mobile network coverage. Operator defined thresholds can be applied in this process. In the event that the coverage is inadequate, the system can alert the system operator and or the new user via their handset.

The validation of network coverage within the zone is determined by comparing the reported observations against a set of criteria. In one embodiment, during the service initialization process, the mobile radio terminal makes a series of measurements of the radio network. Criteria can include a minimum signal strength for the strongest cell reported in each measurement set; a minimum number of cells reported in each measurements set; minimum signal strength requirements for the second strongest cell, third strongest cell, and so on; a minimum number of distinct cells reported across all measurement sets; a minimum number of distinct sites reported across all measurement sets. These criteria can be used in any combination to ensure system performance. The criteria will vary based on the application. For example, an operator may not want to offer a local call replacement service where there is only a single cell operating, albeit strong and reliable, as the area where local call rates would operate would be too large.

An example set of coverage criteria processing is that the mobile radio terminal observe at least one broadcast signal with a signal strength in excess of −95 dBm in each set of radio measurements; at least two cells reported in each measurement set. Variations on these criteria are clearly evident. The minimum signal strength could be any level set by a network operator as the minimum level required to attain the required service quality. The network operator may specify a different minimum number of cells to be hearable. An operator may be satisfied that hearing a single cell provides sufficient coverage. The minimum number of cells could be any value in the range 1 to 7. That is, 1 cell, 2 cells, 3 cells, 4 cells, 5 cells, 6 cells or 7 cells.

### Location Validation

The zone-based service initialisation process described in incorporated reference PCT/AU2006/000478 uses radio measurements made from within the zone to define a zone. Such measurements can be made anywhere where there is radio coverage and consequently a zone can be defined at any location where there is sufficient radio coverage. In some cases, the service provider may wish to ensure that the service zone is aligned with a specified location. In this case, the service initialisation processing can include a check that the initialisation measurements are consistent with the nominated street address. This could be done by using the measurements to compute a location fix for the mobile radio terminal as would be understood by one skilled in the art. An alternative is to directly check the consistency between predictions generated from the server's network propagation model and the initialisation measurements.

As an example, the zone-based service could be supporting a local phone replacement service and legal requirements are such that the phone must be associated with a street address.

The general location validation process is to compare the observed radio signals or parameters derived there from against that which would be expected at the specified location. If the comparison is sufficiently close, the radio measurements are accepted as having been made at the specified location and the zone is generated and sent to each user interested in that zone definition (see FIG. 5 again). Conversely if the match is not sufficiently close the measurements are not accepted and the zone is not generated. Optionally the zone location validation failure is referred back to the system operator (see FIG. 19 again) enabling the operator to take evaluate the situation and undertaking remedial actions such contacting the user, relaxing the validation criteria, or overriding the validation allowing the registration to proceed. Optionally the system provides the system operator with a facility to override a zone registration that has been invalidated based on location criteria. Optionally the operator is provided the details of the validation criteria to assist with the decision. Optionally the operator is provide with the raw measurements to be use to assist with the decision. Optionally the user is notified of the failure by the location server.

In one embodiment, the radio signals broadcast by the radio network are measured by the mobile terminal. These measurements are sent to the location server via the radio network using one of the well known data transmission protocols, for example using SMS. The Location Server processes the measurements and using data from a database determines whether the measurements are consistent with the expected location. In particular the database contains the location of the zone.

### Zone Location Validation Based on Radio Measurements

In one embodiment the validation criteria for zone measurements is a distance criteria. To support such a check the location at which the radio measurement were made needs to be estimated. The zone location can be validated by using the service initialisation measurements to compute a location estimate for the mobile as would be understood by one of ordinary skill in the art and comparing that location against the nominal location for the zone. An example of such a location estimation technique is described in PCT/AU2006/000479 entitled ‘Mobile. Location’, the entire content of which is hereby incorporated by reference. Other examples include Cell ID based methods, and combination of Cell ID and Timing Advance. If the distance between the estimated location of the zone and the specified location exceeds a configured threshold then the zone registration is invalidated, otherwise the registration is validated and processed to generate a zone definition which is in turn sent to users that require that zone definition.

The nominal location for the zone could be specified as a street address that the system geocodes, using techniques well known in the art to generate a coordinate for the nominal location. The nominal location could alternatively be specified via coordinates against a known coordinate frame, for example latitude and longitude relative to the WGS84 reference frame which is then converted using techniques well known in the art to whichever coordinate frame the location server is using.

The specified location of the zone using grid coordinates is denoted S=(x_{S},y_{S}). The estimated location of the zone using grid coordinates is denoted E=(x_{E},y_{E}). The distance threshold is denoted D. The distance between S and E is computed

d=\sqrt{(x_{S}−x_{E})²+(y_{S}−y_{E})²}

If d<=D, the zone measurements are validated as coming from the specified location. If not, the measurements are not validated.

The validation threshold D can simply be a global system parameter specified by the system operator. Ideally the validation threshold includes an allowance for the inaccuracy of the nominal location. Ideally the validation threshold includes an allowance for the inaccuracy of the zone location estimate. Optionally these allowances can vary dynamically based on accuracy metrics reported by the location estimation process. Similarly the specified location may not be perfectly accurate. A system operator may specify a street address and use a reverse geo-coding process to convert the address to a coordinate for use in the distance comparison. This process may introduce an error.

Using a Gaussian statistical model for the errors, the mean and standard deviation of the distance between the nominal zone location and estimated zone location is given by the approximate relationships.

$$μ ≅ {σ}_{S} + {σ}_{E}$$

$$σ ≅ \frac{1}{2} ( {σ}_{S} + {σ}_{E} )$$

Where σ_{S} is the 2DRMS accuracy of the specified location, for example the geocoding process divided by 2√2 and σ_{E} is the 2DRMS accuracy of the location estimation process divided by 2√2. Also σ₁ and σ_{g} are within an order of magnitude of each other. If one error dominates the mean is approximately 1.25 times the larger σ and the standard deviation is approximately half the mean. To avoid too many false alarms, that is zone measurements being invalidated even though they were made from the correct location, the threshold could be set at μ+3σ which would represent a false alarm rate of approximately 0.1%.

In one example, the geocoding has a 2DRMS accuracy of 300 m and the location estimate has a 2DRMS accuracy of 600 m, the nominal location of the zone specified via a street address is geocoded as a grid coordinate (674152, 7816357); and the location estimate is (674904, 7814692). The threshold would be 2250 m. The computed distance is 1827 m which is under the threshold and is thus accepted as having been registered at the nominated location. In the same scenario if the location estimate was (675208, 7814352) the distance is 2266 m. In this case the registration is deemed to have failed the zone location validation test based on the zone appearing too far away from the nominal zone threshold.

### Zone Location Validation Based on Radio Measurements

An alternative to distance based validation is to directly compare signal predictions for the specified location generated using a signal propagation model and the network measurements made by the mobile. One comparison method is to use one similar to that described in incorporated reference PCT/AU2006/000478, for the zone detection process. In that method, the zone detection uses a cost that derives from the difference between the measurements and the zone profile. To validate the origin of the network measurements, the cost is derived from the difference between the measurements and signal parameters as predicted at the specified location. The signal parameters can include signal strength and timing observations such as Timing Advance in GSM. The cost can optionally include the unreported cells cost as described in PCT/AU2006/000347 entitled ‘Enhanced Mobile Location Method and System’, the entire content of which is hereby incorporated by reference. The total cost is compared to a threshold to determine if there is sufficient evidence to believe that the measurements did not derive from the specified location and thus the zone initialization measurements would be rejected.

For each cell that is reported a propagation model is used to predict the value of each signal attribute at the specified zone location. Signal strength can be predicted using a propagation model such as the model developed by Hata (see section 2.7 of Mobile Radio Communications 2^{nd} Ed. Editors Steele and Hanzo. ISBN 047197806X, J. Wiley & Sons Ltd, 1999—Section 2.7 of this reference is hereby incorporated in its entirety) as known to those of ordinary skill in the art. Timing values can be predicted based on the locations of the cells and the specified location of the zone as would be clear to one of ordinary skill in the art. Such predictions of signal strength and timing are described in detail in previously incorporated reference PCT/AU2006/000479.

The following definitions are made:

The i^{th} signal strength observation is denoted by a vector, oᵣ_{ᵢ} where

oᵣ_{ᵢ}=[kᵣ_{ᵢ},rᵢ]^{T}

with
kᵣ_{ᵢ}=the identifier of the i^{th} signal strength observation, and
rᵢ=the signal level (dBm) of the i^{th} signal strength observation.

For a given specified location of the mobile terminal, a cost is calculated based on the observations and corresponding predicted values for the observed parameters. The predicted values are obtained using a mobile radio network propagation model as well known in the art. The model uses information on the configuration of the radio network including the location of cell sites, the height and orientation of cell antennas, the radiation pattern of the antennas as well as the channel frequencies and any other codes allocated to each cell. The model also covers the loss in signal power as radio signals travel from transmitter to receiver. Such models are well known in the radio communications field and can be found in most advanced level texts on the subject. Predicted received signal powers can be generated for any or all cells in the network. These power levels can also be used to derive interference level estimates so that the received quality of a signal from any particular cell can be predicted. The application of network model for predicting received signal levels and interference levels is well known to those skilled in the art of cellular radio network design. Detailed references exist in the literature including, W. C. Y. Lee, Mobile Communications Engineering. McGraw-Hill, 1982, and P. L. H. A. S. Fischer, Evaluation of positioning measurement systems,” T1P1.5/97-110, December 1997, and IEEE VTS committee, Coverage prediction for mobile radio systems operating in the 800/900 MHz frequency range, IEEE Transactions on VTC, Vol 37, No 1, February 1998. The entire contents of these references are hereby incorporated by reference.

The cost is a quantitative representation of the difference between the measurements and the corresponding predictions. In some contexts such a cost function may also be known as a penalty function as is well known to those skilled in the art of numerical optimization.

The cost associated with the signal strength observations is, Cᵣ, which is given by

$${C}_{r} ( x ) = {\sum }_{i = 1}^{{N}_{r}} \frac{{( {r}_{i} - {p}_{r} ( {k}_{{r}_{i}} , x ) )}^{2}}{2 {σ}_{r}^{2}}$$

where

Nᵣ=the number of signal strength observations,

x=the specified location of the mobile

pᵣ(j,x)=the predicted received signal level of the j^{th} cell at location x

σᵣ=the standard deviation of the signal strength measurements.

The i^{th} timing advance observation is denoted by a vector, oₜ_{ᵢ} where

oₜ_{ᵢ}=[kₜ_{ᵢ},tᵢ]^{T}

### With

kₜ_{ᵢ}=the identifier of the i^{th} timing advance observation, and
tᵢ=the i^{th} timing advance observation.

The cost associated with the timing advance observations is, Cₜ, is given by

$${C}_{i} ( x ) = {\sum }_{i = 1}^{{N}_{r}} \frac{{( {t}_{i} - {p}_{t} ( {k}_{{t}_{i}} , x ) )}^{2}}{2 {σ}_{t}^{2}}$$

### Where

Nₜ=the number of timing advance observations, and
pₜ(j,x)=the predicted timing advance of the j^{th} cell at location x
σₜ=the standard deviation of the timing advance measurements.

The i^{th} unreported cell observation is denoted by a scalar, oᵤ_{ₜ} where

oᵤ_{ₜ}=kᵤ_{ₜ}

and
kᵤ_{ₜ}=the identifier of the i^{th} unreported cell.

The cost associated with unreported cell observations is Cᵤ, which is given by

$${C}_{u} ( x ) = - {\sum }_{i = 1}^{{N}_{u}} log [ \frac{1}{2} ( 1 + erf ( \frac{{r}_{u} - {p}_{u} ( {k}_{{u}_{i}} , x )}{\sqrt{2} {σ}_{r}} ) ) ]$$

### Where

Nᵤ is the number of unreported cells,
pᵤ(j,x)=the predicted signal level (dBm) of the j^{th} cell at location x
σᵣ=the standard deviation of the signal strength measurements.
rᵤ=a fixed threshold (in dBm), as described in PCT . . . ,

A means for identifying the relevant unreported cells is described in incorporated reference PCT/AU2006/000479.

The total cost function, C, is given by

C(x)=Cᵣ(x)+Cₜ(x)+Cᵤ(x)

The cost is a chi-squared statistic. If this value is lower than a given threshold then the difference between the observations and the predictions is assumed due random variation alone and thus the observations are deemed to have been made at the specified location. If the value exceeds the threshold, then the observations are not consistent with having been made at the specified location and the measurements are not validated.

Inaccuracy in specified coordinates, for example due to error introduced by reverse geo-coding a street address to a set of coordinates, can be compensates for by an increase in the standard deviation for each measurement. Analysis of the model used for a given observation can be used to determine the effect of an inaccuracy of the specified location and the corresponding increase in the standard deviation required to compensate.

The chi-squared statistic will have a number of degrees-of-freedom equal to the sum of the observations included in each of the partial costs. For example if there were six signal strength observations, one timing advance observation and one unreported cell, then cost would have nine degrees-of-freedom.

To keep the number of false alarms to an acceptable level the threshold is set to be the 99.9% value for the statistic. In one example, in which the number of degrees-of-freedom is 8, the chi-squared value corresponding to a 99.9% threshold is 26.1. If the cost exceeds 26.1 then the initialization measurements are deemed to have not been made at the specified location and the zone is not definition generated. If the cost is under the threshold, the registration is accepted as having been performed at the specified location.

### Grouping Zones

In one aspect of the present invention, a set of zones may be organised into a group. Users are then associated with the group of zones. Any changes to the group composition or any change to a zone within the group are copied to each such associated user. When a zone is added to the group, the zone is copied to each user associated with the group. The operation is comparable to explicitly associating each user with the zone, as previously described.

When a zone is dissociated from a group, the zone is deleted from the mobile terminal of each user associated with the group. The operation is comparable to explicitly disassociating each user with the zone, a process described previously in this specification. When a user is associated with a group of zones each of the zones within the group is associated with the user. Conversely when a user is disassociated with a group of zones, the user is disassociated with each of the zones in the group. When a group is deleted the associated zones are disassociated from each user that was associated with the group. A given zone can be a member of more than one zone group. The zones in a group may overlap, may be spatially disjoint, or a combination of both. A group may also exist with no zones. A group may also contain a single zone. The zone status of a given user with respect to a zone group is the logical OR of the zone status with respect to the zones that are members of the group.

In one aspect of the invention there is a facility to create a zone group; a facility to add a zone to a group; a facility to remove a zone from a group; a facility to delete a group; a facility to associate a user with a group and a facility to disassociate a user from a group.

Where a zone-based application only requires knowledge that a user is on one of a set of zones, a zone group can be used. The approach has the advantage that the application does not need to maintain the details of the zones that are required and the status of each user with respect to each zone that is required to achieve the desired zone detection behaviour. The application is only aware of the zone group and each user's status with respect to that group. An example application is a company that has negotiated a special call rate for employees whenever they are in any company office. A zone is defined and initialized for each of the offices. These zones are grouped. Each of the employees' mobile terminals is associated with the group of zones.

In one embodiment, the details of the zone groupings are maintained in a location server. The mobile terminal only processes zones. All of the facilities required to support the grouping of zones are performed by the location server. The mapping of a zone status into a zone group status is performed in the location server based on zone status provided by the mobile terminal.

In another embodiment of the zone group, the mobile terminal is sent details of the zone grouping by the location server. The mobile terminal computes the logical zone status as the logical OR of the zone states that are members of the group. If the mobile terminal messages to a location server triggered by zone status changes, the mobile terminal can optionally only inform the location server when there has been a change in the zone status of a group as contrasted with triggering a message to the location server when any zone status changes. This has the advantage of reducing the number of messages between mobile terminals and the location server, particularly when the zones within a group overlap. This option also has the advantage of increasing the degree of privacy for the subscriber as the precise location is not revealed. If the user is shown to be in the zone group, the user's location is still ambiguous as they could be in any one of the zones that comprise the group.

In FIG. 21, a zone group G consists of zones A, B, C, and D. A user's zone group status is “in” zone if they are in zone A, zone B, zone C or zone D or any combination of the three. Hence when the user is at points 1, 2, or 3, the user would be considered to be “in” the zone group G; and “out” when at points 4 or 5.

The physical zones that are so grouped into a logical zone can be spatially separate or they may overlap.

### User and Zone Management

In another aspect of the invention, the system provides facilities to assist with the management of a zone-based system, applications dependent upon that application and the users of that system.

Such facilities include: the ability of the system to obtain from any mobile terminal; the ability to query the zone status of the mobile terminal at any time; the ability to suspend the service of the subscriber as well as the ability to unsuspend the service once it is suspended; the ability to suspend the service for a specific zone or group of zones; and the ability to have a privacy mode.

Management of a zone-based system is facilitated by the following aspects of the invention.

### Real-Time Zone Status

In one aspect of the invention there exists a facility to obtain the current zone status of a given mobile terminal. The system provides an interface enabling the operator sends a request the system to obtain the current zone status for one or more mobile terminals. Optionally the operator request can specify the type of status required: the zone status or zone group status. Optionally the operator request can include a command to periodically send such updates. Optionally the operator request can include a command to send a specified number of periodic zone status updates. Optionally the current zone status is provided back to the system operator.

In one embodiment, the zone detection is performed in the mobile terminal. In this embodiment the system operator request for a zone status update would be translated into a command within a message to the specified mobile terminal(s). The mobile terminal would then respond to that command with the requested zone data. If so requested the mobile terminal would also provide periodic zone status updates. If so requested the mobile would stop sending zone status updates once it had sent the required number of updates. If so requested the mobile would return zone group statuses. Optionally the mobile can delay responding to the request until it next receives radio network measurements to ensure that the response it sends is based on the current observations.

In an alternative embodiment where the zone detection is performed in the network, the system can call the mobile terminal so as to effect the capture of current radio data from the mobile enabling the current zone status(es) to be computed.

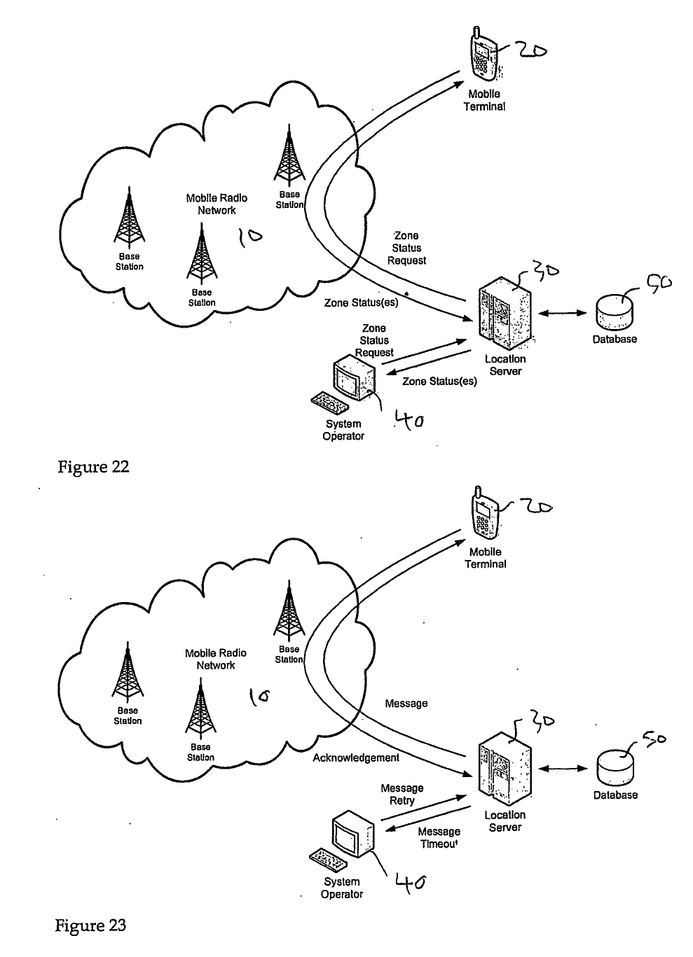

This aspect of the invention has a number of applications, including the detection of potential problems and the detection of potential fraud. If the system is operating in a mode whereby the mobile terminals implement the zone detection process and only send a zone status message if there has been a change of zone state and if a given mobile has not sent a zone status update for a configured period; for example 24 hours, then the system can send a request to that mobile to obtain the current zone status. If the message is delivered to the mobile but the mobile does not respond, this indicates that the mobile is operating however either there is a problem with the mobile or there is fraudulent use of the system. In a further aspect the zone status response from the mobile can be compared with the zone status held by the server. A discrepancy between the two can be flagged to the system operator as a potential problem with a mobile or as evidence of fraudulent use. For example a mobile has three zones A, B, and C and the server shows the mobile to be in zone A and not in B and C. A request by the server to the mobile to provide a status update reveals that the mobile is not in any of the zones. Since the mobile should have automatically sent a message at some stage in the past to indicate that it had left zone A, the discrepancy is an indication of a potential fault or fraudulent use. In another use of the feature is if a user contacts the system operator complaining of a problem, the operator can request that the mobile radio terminal provide a status update to determine if the mobile is operating correctly. This scenario is illustrated in FIG. 22.

### Suspending Service

In one aspect of the invention there exists a facility to suspend the service for one or more users. There is also a facility to unsuspend the service for one or more users. The system provides an interface enabling the operator to send a request the system suspend a user. The system provides an interface enabling the operator sends a request the system unsuspend a user. When a user is suspended, their zones are set to a default state. Optionally when suspended, the user's mobile terminal ceases all indications of the service. Optionally the server sends a message to the user, for example a text SMS, notifying them that the service has been suspended or unsuspended. Optionally, the mobile terminal notifies the user when a command is received to suspend or unsuspend the service.

In one embodiment, service suspension is implemented in the mobile terminal whereby the system sends a message to the mobile terminal instructing it to suspend the service. Via a similar message the server can instruct the mobile terminal to unsuspend the service. The preferred default zone state is for all zones to behave as though the mobile is not in the zone. When service is suspended the mobile terminal will not display whether the mobile is in or out of the suspended zone(s). Optionally the mobile terminal will provide an indication to the user that the service is suspended. When the location server is queried about the status a given zone for a given user and the zone is suspended, the system will preferably report that the zone is suspended. Alternatively the system will report the user as being out of the zone.

The ability to suspend the service enables the system operator a flexible means of dealing with users with unpaid bills, significant service problems, and fraudulent use. Such problems could be dealt with by deleting the users from the system but re-enabling such users would then require that they have to re-initialise each of the zones they use. The service suspension alleviates this problem.

### Suspend Zone

In one aspect of the invention there exists a facility to suspend the service for one or more zones for one or more users. There is also a facility to unsuspend the service for one or more zones for one or more users. The system provides an interface enabling the operator to send a request that the system suspend a specified zone for specified users. The system also provides an interface enabling the operator to send a request the system to unsuspend a specified zone for specified users. Optionally the system provides a facility for the system operator to suspend a zone for all users that use that zone. Optionally the system provides a facility for the system operator to unsuspend a zone for all users that use that zone. The suspension of zones can optionally specify if the zone to be acted upon is a zone or a zone group. Optionally the system sends the user a message, such as a text SMS, when it suspends one or more zones. Optionally the system sends the user a message when it unsuspends one or more zones. Optionally the mobile terminal notifies the user when a suspend or unsuspend command is received. When a zone is suspended the status of such a zone is deemed to be suspended. An alternative implementation is for such zones to be deemed away irrespective of the actual physical location of a mobile with respect to that zone.

In one embodiment, the zone detection is implemented in the mobile terminal. To suspend a zone the server sends the mobile a message specifying the zone(s) to be suspended. The mobile terminal then suspends the zone. Optionally, when a zone is suspended the user is not permitted to initialize the zone. Optionally when suspended the mobile terminal will provide an indication that a zone is suspended. Similarly for unsuspending one or more zones, the server sends a message to the mobile instructing the mobile to unsuspend a zone and reversing any restrictions placed on the suspended zone. One implementation is that the mobile reports the state of any zone in suspension as suspended. Zone suspension only affects the operation of zone detection. Updates to zone definitions may arise due to changes in the network.

An alternative embodiment is to implement the service suspension in the location server. From the user's perspective the service will appear to be operating correctly. However when the location server is queried about the status a given zone for a given user and the zone is suspended, the system will report that the zone is suspended even thought the location server will know the true zone status as reported by the mobile. Alternatively the system will report the user as being out of the zone irrespective of the true state.

Yet another embodiment for service suspension is to delete the suspended zones from the mobile terminal. Restoration of the service, however, will require all of the zone information to be resent to the mobile. This has the disadvantage over the preferred approach of requiring more data to be sent than a message that unsuspends the suspended zone. There is also the disadvantage of the confusion that could arise due to there being no distinction on the mobile terminal between a suspended service and a deleted service.

For example, a mobile has three zones A, B, and C and zone C has been suspended on that mobile by the system operator. The mobile is currently in zone A. In one embodiment, where the zone detection is performed in the mobile, the zone status would reported by the mobile as in zone A, not in zone B, and suspended for zone C. The mobile now moves such that it would be in zone C. The zone status would be reported by the mobile radio terminal as not in zone A, not in zone B, and suspended for zone C. Zone C is now unsuspended. The zone status would reported by the mobile as not in zone A, not in zone B, and in for zone C.

In another example a mobile M has three zones A, B, and C; a mobile N has two zones C and C. Zone C has been suspended for all users. The server has sent messages to mobile M and also to mobile N to suspend zone C. N and M happen to be in the same zone A. Mobile M would report that it is in zone A, not in zone B and is suspended for zone C. Mobile N would report that is suspended for zone C and not in zone D.

In another example a system using zone groups has a mobile M and a mobile N and bother are associated with a group G containing zones A and B. Mobile M is also associated with a zone E. The server suspends zone group G on mobile M. The mobile M is in zone A. The zone status would be reported by the mobile M as suspended for zone A, suspended for zone B, and not in for zone E. The mobile N is in zone B. The zone status would be reported by the mobile N as not in zone A and in for zone B. Now consider the same scenario but for which the operator has suspended the zone group G for all users. The zone status would be reported by the mobile M as suspended for zone A, suspended for zone B, and not in for zone E. The zone status would be reported by the mobile N as suspended for zone A and suspended for zone B.

It will be clear to one of ordinary skill in the art based on the description and examples provided how to apply the zone suspension facility to the various modes of system operation described in this invention but not mentioned explicitly in the examples.

Suspension of a service can be used to implement time-based and date-based behaviour. For example if a child monitoring service monitors a child's presence at a school, the service need only be active during school hours. The system can suspend the service at the end of each school day and unsuspend the service at the start of each school day.

Zone suspension can be used in the event that a bill for the service has not been paid. For example an employer has not paid their bill for a zone-based phone billing service. The system then suspends the zones associated with this service and thus each employee's mobile terminal associated with those zones no longer has a zone-based service for the work-related zones.

### Privacy Mode

In one aspect of the invention there is a facility for a user to make information pertaining to their location private. Similarly, there is a facility for a user to deactivate the privacy feature.

In the preferred embodiment the feature is activated from the user's mobile terminal by the user. In one mode of operation the user makes a selection of one or more of the installed zones to make private. In an additional or alternative mode of operation, the user selects all zones to be made private. In one mode of operation the user makes a selection of one or more of those zones made private to be made non-private. In an additional or alternative mode of operation the user selects all zones to be made non-private. When the privacy setting for one or more zones is changed by the user, the mobile terminal sends a message to the server indicating the privacy setting for each affected zone.

An alternative embodiment is to provide a self-service feature via the internet to enable a user to activate or deactivate the privacy feature. The feature would offer the same options as described in the above embodiment. Yet another embodiment is to provide a self-service feature via the telephone to enable a user to activate or deactivate the privacy feature. Yet another embodiment is to provide a service via customer service through which an operator of the service can enable and disable the privacy mode when so requested by a user. In one or more of these embodiments, the location server is notified of the zones affected and the privacy setting for each zone. Optionally the location server sends a message to the user's mobile terminal listing the zones affected and the privacy setting for each zone. As would be obvious to those skilled in the art any combination of the described embodiments can be offered in parallel.

In all of the embodiments, the control over privacy settings can be offered for logical zones, for physical zones or for both. When a logical zone is made private the associated physical zones are implicitly made private. Similarly when a logical zone is made non-private, the associated physical zones are also made non-private. When determining zone status of a zone group the logic is as described elsewhere in this specification except that physical zones marked as private are ignored. If all physical zones in a zone group are marked as private then the zone group's state is private.

The intention of privacy mode is not to reveal the user's presence with respect to one or more physical zones. When reporting zone status, the handset reports any zone made private as private instead of home or away. When a given zone is private the mobile does not send a zone status update message to the server when the mobile moves in or out of a zone marked as private. Optionally the mobile terminal does not display the zone status for zones marked private.

When the location server reports the zone status of a given zone for a given user and that zone has been marked as private the server shall indicate that the zone status is private.

### Error Detection and Handling

In a system with a large number of users who are mobile and for which there is not a permanent connection between the users and the central server, inconsistencies between the user and the server are likely to arise. For example a new zone profile sent from the server to the mobile using SMS may not get delivered, resulting in that the server's view of what zones are stored on that mobile is different to the mobile's view.

### Acknowledging Messages

In one aspect of the invention is the implementation of a messaging policy whereby certain server originated messages must be acknowledged by the recipient mobile via a return message as shown in FIG. 23. This is particularly useful for non-session based protocols such as SMS which uses a store-and-forward protocol. The acknowledgement may take the form of an explicit acknowledgement message. The acknowledgement may be implicit in that the original message required a response; receipt of that response implicitly indicating that the message was received. Optionally if a mobile has not acknowledged a given message within a configured interval the server re-sends the message. Optionally the server only makes a configured number of resend attempts. Optionally if a mobile has not acknowledged a given message within a configured interval the server alerts the system operator using protocols well known in the art such as SMTP and SNMP. Optionally the server resends the message and notifies the system operator. In another aspect of the invention the operator is provided with a facility to command the server to resend a message once all of the retry attempts have been exhausted.

In another aspect of the invention is the implementation of a messaging policy whereby certain mobile originated messages must be acknowledged by the recipient mobile via a return message. If a response is not sent within a configured interval the mobile resend the message. Optionally the mobile only makes configured number of retries before alerting the user to a communication failure.

Note that the acknowledgement policy is only to acknowledge the receipt of the original message. Acknowledgement messages need not be acknowledged via return message. To do so would result in an endless series of messages between the server and the mobile.

Acknowledgement of messages has the advantage of reducing the risk of the data in the mobiles and location server becoming unsynchronised.

In some implementations there is an intermediate system between the server and the mobile. In particular where SMS is the message transport mechanism between the server and the mobile there is an SMSC. In such cases the system can optionally also track the state of the message through the intermediate device by having the device acknowledge when it has successfully passed the message to the next device. In the case of an SMSC, the SMSC informs the server each time it delivers a message to a mobile in behalf of the server. When a message is not acknowledged by a mobile the server can now differentiate between a message that was not delivered and one where the mobile received the message but failed to acknowledge it. Optionally the SMSC can notify the location server when it deletes a given message having timed-out the message having been unable to deliver it to the mobile.

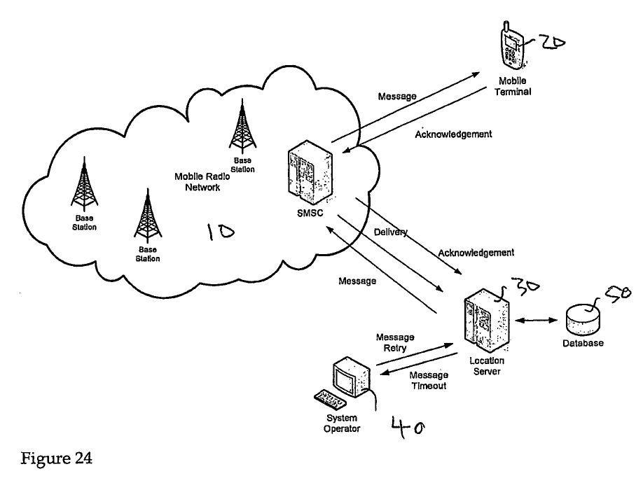

The server can optionally apply a time-out to the delivery of a message by an intermediate device such as an SMSC. Optionally the server can have a configurable number of retry attempts in the event a message times out. Optionally the system operator has a facility to enable the number of retry attempts to be configured. Optionally if a message is timed-out the system operator is notified of the message failure using well known protocols such as SNMP and SMTP. This scenario is shown in FIG. 24.

### Error Detection in the Location Server

In one aspect of the invention the location server verifies the consistency of each transaction message it receives. The location server checks one or more of the following depending upon the nature of the message:
That an incoming message is from a user known to the server as identified by the user's MSISDN or other unique key contained in the message
That all zones listed in a zone status update message are all associated with the user
That all zones associated with a user are included in a zone status update message
That a user sending a zone registration message for a given zone has permission to register that zone
That if a zone status update message is accompanied by radio network measurement data, the server validates the zone status based on the radio measurements.

Optionally when a consistency check fails the location server notifies the system operator using protocols well known in the art such as SMTP and SNMP. Optionally when the location server detects an error it sends a message notifying the user.

### Error Detection in the Mobile Terminal

In one aspect of the invention the mobile terminal verifies the consistency of each transaction message it receives. The location server checks one or more of the following depending upon the nature of the message:
That a command to delete a zone references a zone known to the mobile
That a command to suspend a zone references a zone known to the mobile
That a command to make a zone private references a zone known to the mobile

Optionally when a consistency check fails, the mobile sends a message to the location server to notifies it of the problem. Optionally the location server in turn optionally the system operator. Optionally when the mobile detects an error it displays a message to the user.

Change Hardware

In one embodiment of the location based service described in previously incorporated reference PCT/AU2006/000478, the zone profiles and application parameters are stored in the user's mobile terminal; either in the mobile phone itself or the SIM card. In one aspect of the invention there is a facility that enables all of the zone-based data and application settings for a given user to be copied to a new device. To facilitate this process the location server maintains a copy of all zones data and application settings for each user.

As an example of the facility consider the implementation where the zone-based system is implemented on a SIM card. A user loses their phone and thus their SIM card. The network deactivates the SIM card and reissues a new SIM card which the user places in a replacement phone. The location server is then instructed to copy all of the zone data and applications settings to the new SIM thus restoring the zone-based service without having to re-provision the zones and without having to re-register the zones.

As an example of configuring an application parameter consider the rate at which a user's mobile terminal updates the zone status is made. In one implementation of the zone-based location system the zone update rate is made a configurable option in the software that implements parts of the zone-based location system in the mobile terminal. The zone status update rate is set to 120 seconds which is found to provide an unsatisfactory level of responsiveness to zone entry and exit. To increase the responsiveness of the zone detection, the location server sends a message to each mobile phone to change the parameter to 60 seconds.

It will be understood that the above has been described with reference to various particular embodiments and that many other variations and modifications are possible within the scopes of the various aspects of the invention.

It will also be understood that the term “comprise” and any of its derivatives (e.g. comprises, comprising) as used in this specification is to be taken to be inclusive of features to which it refers, and is not meant to exclude the presence of any additional features unless otherwise stated or implied.

1. A method of propagating to a user of a zone, information relating to the zone, the method comprising:
associating the user with the zone; and
transmitting information relating to the zone to the associated user.

2. A method as claimed in claim 1 further comprising associating a plurality of users with the zone.

3. A method as claimed in claim 1 further comprising associating a plurality of zones with the user.

4. A method as claimed in claim 3 further comprising associating the plurality of zones with a plurality of users.

5. A method as claimed in claim 1 wherein the information relates to a change in size of the zone.

6. A mobile radio communications network having at least one zone and at least one user of that zone, the mobile radio communications network comprising:
a database having stored thereon a profile of the at least one zone and association data associating the at least one user with the at least one zone;
a receiver for receiving information relating to the at least one zone; and
a transmitter for transmitting information relating to the at least one zone to the associated at least one user.

7. A mobile radio communications network as claimed in claim 6, wherein the database further comprises association data associating a plurality of users with the at least one zone.

8. A mobile radio communications network as claimed in claim 6 wherein the database further comprises profiles for a plurality of zones.

9. A mobile radio communications network as claimed in claim 8 wherein the database further comprises association data associating the at least one user with the plurality of zones.

10. A mobile radio communications network as claimed in claim 8 wherein the database further comprises association data associating a plurality of users with the plurality of zones.

11. A database for use with a mobile radio communications network having at least one zone and at least one user of the at least one zone, the database having stored thereon:
a profile of the at least one zone and association data associating the at least one user with the at least one zone.

12. A database as claimed in claim 11 further comprising association data associating a plurality of users with the at least one zone.

13. A database as claimed in claim 11 further comprising profiles for a plurality of zones.

14. A database as claimed in claim 13 further comprising association data associating the at least one user with the plurality of zones.

15. A database as claimed in claim 13 further comprising association data associating a plurality of users with the plurality of zones.

16. A method of making available one or more zone profiles to a mobile radio terminal in a mobile radio communications network, the method comprising:
detecting the mobile radio terminal entering a zone in the mobile radio communications network; and
upon detecting that the mobile radio terminal has entered the zone, transmitting a transmission making available to the mobile radio terminal, a profile of the at least one sub-zone associated with the zone.

17. A method as claimed in claim 16 wherein the transmission comprises the profile of the at least one sub-zone.

18. A method as claimed in claim 16 wherein the transmission comprises an instruction to activate the profile of the at least one sub-zone in the mobile radio terminal.

19. A method as claimed in claim 18 further comprising:
detecting when the mobile radio terminal leaves the zone; and
upon detecting that the mobile radio terminal has left the zone, transmitting a further transmission to the mobile radio terminal, making unavailable, the profile of the at least one sub-zone.

20. A method as claimed in claim 19 wherein the further transmission comprises instructions to the mobile radio terminal to delete the profile of the at least one sub-zone.

21. A method as claimed in claim 19 wherein the further transmission comprises instructions to the mobile radio terminal to deactivate the profile of the at least one sub-zone.

22. A method as claimed in claim 16 further comprising;
upon detecting that the mobile radio terminal has entered the zone, determining whether the zone has one or more sub-zones associated therewith.

23. A mobile radio communications network for providing one or more zone profiles to a mobile radio terminal, the mobile radio communications network comprising:
a database containing profiles for a zone and at least one sub-zone;
a zone transition detector for detecting when the mobile radio terminal enters the zone; and
a transmitter for transmitting a transmission to the mobile radio terminal when the zone detector detects that the mobile radio terminal has entered the zone, to provide the profile of the at least one sub-zone to the mobile radio terminal.

24. A mobile radio terminal for use in a mobile radio communications network having a zone and at least one sub-zone of the zone, the mobile radio terminal comprising:
a memory having a profile of a zone stored thereon;
a transmitter for transmitting a signal to the mobile radio communications network upon the mobile radio terminal entering the zone;
a receiver for receiving from the mobile radio communications network a transmission providing a profile of a sub-zone within the zone; and

25. A mobile radio terminal as claimed in claim 24 wherein the memory is a SIM card.

26. A mobile radio terminal for use in a mobile radio communications network having a zone and at least one sub-zone associated with the zone, the mobile radio terminal having:
a memory having profiles of the zone and the at least one sub-zone stored thereon, wherein upon receipt of an instruction from the mobile radio communications network, the at least one sub-zone profile is activated.

27. A mobile radio terminal as claimed in claim 26 wherein the instruction from the mobile radio communications network is transmitted upon the mobile radio terminal entering the zone.

28. A method of controlling the size of a zone in a mobile radio communications network, the zone being defined by at least one signal strength measurement for a cell in the mobile radio communications network, the method comprising:
varying a standard deviation for the at least one signal strength measurement.

29. A method as claimed in claim 28 wherein the method further comprises varying the standard deviation for respective signal strength measurements for each cell in the zone definition.

30. A method as claimed in claim 28 wherein the zone size is made smaller by decreasing the standard deviation.

31. A method as claimed in claim 28 wherein the zone size is made larger by increasing the standard deviation.
